(19) United States
(12) Patent Application Publication
(10) Pub. No.: US 2026/0104016 A1
(43) Pub. Date: Apr. 16, 2026

(54) ENGINE CONTROL SYSTEM AND METHODS

(71) Applicant: INNIO Jenbacher GmbH & Co OG, Jenbach (AT)

(72) Inventors: Johannes Huber, Kramsach (AT); Herbert Schaumberger, Münster (AT)

(21) Appl. No.: 18/912,430

(22) Filed: Oct. 10, 2024

(51) Int. Cl. F02D 41/14; F02D 41/00

(52) U.S. Cl. CPC F02D 41/1458; F02D 41/0027; F02D 41/1406; F02D 2041/1409; F02D 2041/1433; F02D 2041/1472; F02D 2200/0612

(57) ABSTRACT

A method includes initializing an estimated fuel property associated with a fuel of an engine system. The method also includes determining an estimated quantity associated with operation of the engine based on a model. The method also includes receiving a signal indicative of a measured quantity corresponding to the estimated quantity. The method also includes determining the measured quantity based on the received signal. The method also includes determining a residual based on the estimated quantity and the measured quantity. The method also includes updating the estimated fuel property based on the residual. The method also includes controlling one or more operational parameters of the engine based on the update of the estimated fuel property.

### BACKGROUND

The subject matter disclosed herein relates to a system and methods for estimation of fuel properties for control of an engine.

During the operation of engines, there may be fluctuations in one or more fuel properties of the fuel. For example, there may be fluctuations in the stoichiometric air fuel ratio of the fuel, the lower heating value of the fuel, or a content (e.g., fraction) of a constituent of the fuel. These changes in fuel properties may have unforeseen effects on one or more state variables of the engine, such as the output power, the output torque, and/or the engine velocity. Additionally, changes in the concentration of one or more constituents of the fuel over time may affect the engine performance. Accordingly, there is a need to mitigate the effects of variations in fuel properties and fuel constituent concentration variation on the operation of engines.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In an embodiment, a method includes initializing an estimated fuel property associated with a fuel of an engine system. The method also includes determining an estimated quantity associated with operation of the engine based on a model. The method also includes receiving a signal indicative of a measured quantity corresponding to the estimated quantity. The method also includes determining the measured quantity based on the received signal. The method also includes determining a residual based on the estimated quantity and the measured quantity. The method also includes updating the estimated fuel property based on the residual. The method also includes controlling one or more operational parameters of the engine based on the update of the estimated fuel property.

In another embodiment, a system includes an engine and a controller having a memory and a processor. The controller is configured to initialize an estimated fuel property associated with a fuel of the engine. The controller is also configured to determine an estimated quantity associated with operation of the engine based on a model. The controller is also configured to receive a signal indicative of a measured quantity corresponding to the estimated quantity. The controller is also configured to determine the measured quantity based on the received signal. The controller is also configured to determine a residual based on the estimated quantity and the measured quantity. The controller is also configured to update the estimated fuel property based on the residual. The controller is also configured to control one or more operational parameters of the engine based on the update of the estimated fuel property.

In another embodiment, a tangible, non-transitory, computer-readable medium, including computer-readable instructions that, when executed by one or more processors of an electronic device, cause the electronic device to initialize one or more estimated fuel properties associated with a fuel of an engine system. The computer-readable instructions also cause the electronic device to determine the one or more estimated fuel properties based on residuals. The computer-readable instructions also cause the electronic device to correct the one or more estimated fuel properties based on a model relating the one or more estimated fuel properties. The computer-readable instructions also cause the electronic device to estimate an additional fuel property based on the corrected one or more estimated fuel properties. The computer-readable instructions also cause the electronic device to determine a fuel fraction of the fuel based on the corrected one or more estimated fuel properties and the additional fuel property. The computer-readable instructions also cause the electronic device to update a parameter of a model-based controller based on the corrected one or more estimated fuel properties and the additional fuel property. The computer-readable instructions also cause the electronic device to update a calibration of the model-based controller based on the corrected one or more estimated fuel properties, the fuel fraction, or a combination thereof.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an embodiment of a combustion system having an engine system, in accordance with aspects of the present disclosure;

FIG. 2 is a block diagram of an embodiment of a first control scheme executed by a controller of the combustion system of FIG. 1, in accordance with aspects of the present disclosure;

FIG. 3 is a flow chart of an embodiment of a process for updating a stoichiometric air fuel ratio (sAFR) estimate, in accordance with aspects of the present disclosure;

FIG. 4 is a flow chart of an embodiment of a process for updating a lower heating value (LHV) estimate, in accordance with aspects of the present disclosure;

FIG. 5 is a flow chart of an embodiment of a process for updating a hydrogen (H₂) fraction estimate, in accordance with aspects of the present disclosure;

FIG. 6 is a flow chart of an embodiment of a process for updating a diluent concentration (C_{diluent}) estimate, in accordance with aspects of the present disclosure;

FIG. 7 is a graph showing examples of the residuals determined by the control system of FIG. 2, in accordance with aspects of the present disclosure;

FIG. 8 is a series of graphs showing an estimated generated power and a measured generated power that may be used for diagnosing a type of failure mode, in accordance with aspects of the present disclosure;

FIG. 9 is a block diagram of an embodiment of a second control scheme executed by the controller of the combustion system of FIG. 1, in accordance with aspects of the present disclosure;

FIG. 10 is a flow chart of an embodiment of a process of the second control scheme of FIG. 9 for updating one or more fuel properties associated with operation of the engine system, in accordance with aspects of the present disclosure;

FIG. 11 is a flow chart of an embodiment of a process for updating the one or more fuel properties of FIG. 10, in accordance with aspects of the present disclosure;

FIG. 12 is a flow chart of an embodiment of a process for controlling the engine system of FIG. 1 based on the updated one or more fuel properties of FIG. 10, in accordance with aspects of the present disclosure;

FIG. 13 is a series of graphs showing an embodiment of simulation results of controlling the engine system based on the updated one or more fuel properties of FIG. 10, in accordance with aspects of the present disclosure; and

FIG. 14 is a flow chart of an embodiment of a process including the first control scheme of FIG. 2 and the second control scheme of FIG. 9 for operation of the engine system of FIG. 1, in accordance with aspects of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

The present disclosure presents a first control system (e.g., first control scheme) and methods for updating fuel properties of a fuel used for an engine during operation based on estimated and measured values, and modifying one or more engine controllers based on the correction. Specifically, the present disclosure presents a control system (e.g., adaptive control system) that computes the residuals of one or more measured quantities related to operation of the engine and updates one or more corresponding fuel properties based on these residuals. As described herein, the fuel properties are updated by solving a system of differential equations as part of an initial value problem. The updated fuel properties may then be used to update one or more controllers used for controlling the engine. As discussed herein, the estimated fuel properties may include a stoichiometric air fuel ratio, a lower heating value, a fuel constituent content (e.g., hydrogen fraction), or a combination thereof. Additionally or alternatively, the one or more controllers that may be updated based on the estimated fuel properties include a power controller, a speed controller, a fuel controller (e.g., fuel dosage controller), or a combination thereof. Finally, simulation results of the disclosed control system and methods are presented showing that the estimated fuel properties determined by the disclosed system and methods track the measured (e.g., empirical) fuel properties when a load of the engine is changed and when a fraction of the fuel is changed. The foregoing estimated fuel properties may improve the efficiency and performance of the first control system (e.g., first control scheme), while also improving efficiency and performance of the engine.

Additionally, the present disclosure presents a second control system (e.g., second control scheme) and methods for accounting for estimation of fuel properties based on a correction of a diluent concentration of the fuel over time. As discussed herein, a throttle volumetric flow feedback term and/or an oxygen concentration measurement feedback term may be used to correct a diluent concentration of a fuel. The corrected diluent concentration may then be used to determine updated fuel properties. In certain embodiments, the updated fuel properties may include a molecular weight, a ratio of specific heats, a specific gravity, or a combination thereof. The updated fuel properties may be used to update one or more models (e.g., a governor model, a fuel valve model, a throttle model, etc.) associated with control of the engine. As discussed herein, the correction of the diluent concentration in the second control scheme may be combined with the first control scheme for updating one or more fuel properties (e.g., stoichiometric air fuel ratio, lower heating value, etc.) based on determining one or more residuals and solving a system of differential equations. The foregoing estimated fuel properties may improve the efficiency and performance of the second control system (e.g., second control scheme), while also improving efficiency and performance of the engine.

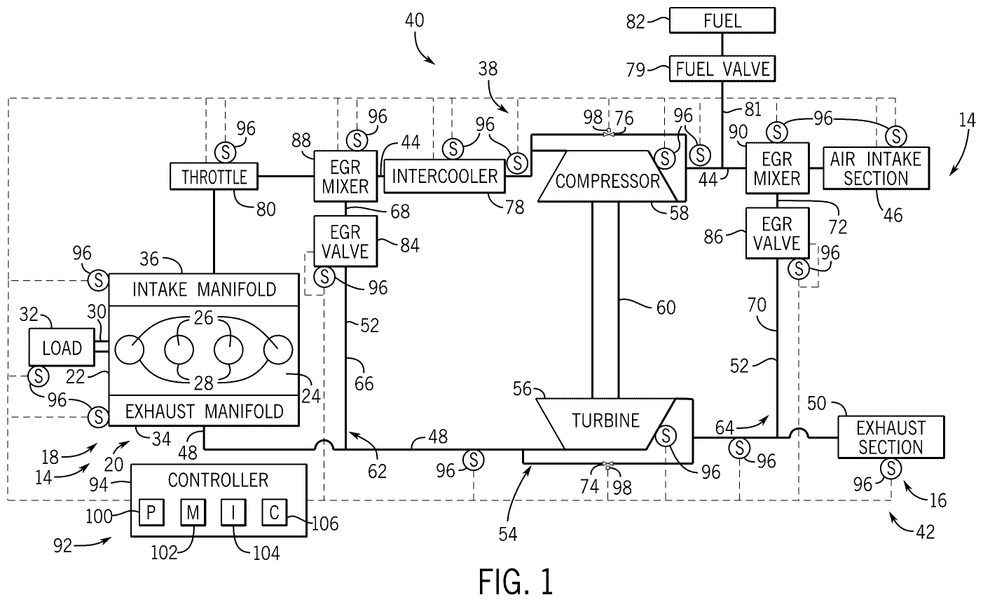

With the foregoing in mind, FIG. 1 is a schematic diagram of an embodiment of a combustion system 14 having an engine system 16. In the illustrated embodiment, the combustion system 14 includes an exhaust system 18 and an engine system 16 having one or more engines 20 (e.g., reciprocating engine). The one or more engines 20 may include the same or different reciprocating piston-cylinder internal combustion engines. Each of the engines 20 may include a two-stroke engine, a four-stroke engine, or other type of reciprocating engine. The reciprocating engine 20 may also include any number of combustion chambers, pistons, and associated cylinders (e.g., 1-24) in one cylinder bank (e.g., inline) or multiple cylinder banks (e.g., left and right cylinder banks) of a V, W, VR (a.k.a. Vee-Inline), or WR cylinder bank configuration. For example, in certain embodiments, the reciprocating engine 20 may include a large-scale industrial reciprocating engine having 6, 8, 12, 16, 20, 24 or more pistons reciprocating in cylinders. In some such cases, the cylinders and/or the pistons may have a diameter of between approximately 13.5-31 centimeters (cm). In certain embodiments, the cylinders and/or the pistons may have a diameter outside of the above range. The fuel utilized by the reciprocating engine 20 may be any suitable gaseous fuel, such as natural gas, associated petroleum gas, hydrogen (H₂), propane (C₃H₈), biogas, sewage gas, landfill gas, coal mine gas, butane (C₄H₁₀), ammonia (NH₃) for example. The fuel may also include a variety of liquid fuels, such as gasoline, diesel, methanol, or ethanol fuel. For example, the foregoing fuels may be used for a fuel 81 from a fuel supply 82 as discussed in detail below. The fuel properties of the fuel may vary over time and thus the disclosed embodiments provide for fuel property estimations to improve control of the combustion system 14. In the illustrated embodiment, the fuel 81 is injected upstream of the compressor 58. Additionally or alternatively, the fuel 81 may be injected downstream of the compressor 58. In certain embodiments, the fuel 81 may be injected at multiple locations throughout the combustion system 14.

The reciprocating engine 20 includes an engine block 22 having a plurality of piston-cylinder assemblies 24, each having a piston 26 disposed within a cylinder 28. Each piston 26 is configured to reciprocate within the cylinder 28 in response to combustion in a combustion chamber of the engine block 22, thereby driving rotation of a crankshaft coupled to a shaft 30 driving a load 32 (e.g., a compressor, generator). In some embodiments, the load 32 may be a generator configured to provide electrical power to operate additional components of the gas production site 10. Additionally, the reciprocating engine 20 includes an exhaust manifold 34 and an intake manifold 36. The intake manifold 36 is coupled to an intake circuit 38 of an intake system 40, while the exhaust manifold 34 is coupled to an exhaust circuit 42 of the exhaust system 18. The intake circuit 38 includes one or more intake lines 44 extending between an air intake section 46 and the intake manifold 36, thereby supplying air into the reciprocating engine 20. For example, the air intake section 46 may include an air intake duct, air filters, or other features to process the air coming into the intake system 40.

The exhaust system 18 has one or more exhaust lines 48 extending between an exhaust section 50 and the exhaust manifold 34. For example, the exhaust section 50 may include a silencer, a catalytic converter, a discharge duct, or other equipment to facilitate discharge of the exhaust gas into the environment. As noted above, the exhaust system 18 also may include one or more EGR lines 52 to facilitate exhaust gas recirculation between the exhaust circuit 42 and the intake circuit 38. For example, the EGR lines 52 may include one or more EGR lines upstream and/or downstream of a turbocharger 54, which includes a turbine 56 disposed along the exhaust line 48, a compressor 58 disposed along the intake line 44, and a shaft 60 coupling together the turbine 56 and the compressor 58. The turbocharger 54 is driven by exhaust gas passing through the exhaust line 48 and through the turbine 56, which in turn rotates the shaft 60 coupled to the compressor 58. The compressor 58 operates to compress an airflow from the air intake section 46 flowing along the intake line 44 into the intake manifold 36.

As noted above, the EGR lines 52 may include EGR lines only upstream of the turbocharger 54, only downstream of the turbocharger 54, or both upstream and downstream of the turbocharger 54. For example, the exhaust circuit 42 may include an exhaust gas recirculation (EGR) circuit 62 and an EGR circuit 64 disposed at different positions upstream and downstream relative to the turbocharger 54. In the illustrated embodiment, the EGR circuit 62 has EGR lines 66 and 68 coupled to the respective exhaust line 48 and the intake line 44. Similarly, the EGR circuit 64 has EGR lines 70 and 72 coupled to the respective exhaust line 48 and the intake line 44. In the illustrated embodiment, the EGR circuit 62 may be described as a high pressure EGR circuit, due to its location upstream from the turbine 56, whereas the EGR circuit 64 may be considered a low pressure EGR circuit based on its position downstream from the turbine 56.

The combustion system 14 may include a variety of components along the exhaust system 18 and the intake system 40. As discussed above, the turbine 56 of the turbocharger 54 is disposed along the exhaust line 48 of the exhaust system 18. The turbocharger 54 also may include a bypass valve or waste gate valve 74 configured to open and close to vary a bypass of exhaust gas around the turbine 56. The exhaust section 50 also may include various components, such as the silencer, catalytic converter, or other exhaust gas treatment components.

Similarly, the intake system 40 may include a bypass valve 76 configured to open and close to vary a bypass flow of air intake around the compressor 58. The intake circuit 38 of the intake system 40 may include an intercooler 78 configured to control the temperature of the air intake and a fuel control valve 79 configured to control an amount of mixing between fuel 81 and air from the air intake section 46 (e.g., a ratio of fuel to air) before directing the fuel and air mixture to a throttle 80 configured to control the flow of the air intake and fuel 81 from a fuel supply 82 into the intake manifold 36. For example, the intercooler 78 may be a heat exchanger configured to transfer heat away from the intake air after compression in the compressor 58, thereby cooling the compressed air to a suitable temperature prior to intake into the reciprocating engine 20 via the intake manifold 36. The throttle 80 also may be configured to control the fluid flows (e.g., air, recirculate exhaust gas, and fuel) into the intake manifold 36 downstream from the intercooler 78. The air intake section 46, as discussed above, may include air filters, intake ducts, or other equipment to properly intake and route the air flow into the reciprocating engine 20.

Each of the EGR circuits 62 and 64 is configured to recirculate an exhaust gas being discharged along the exhaust line 48 into the intake line 44 for return into the intake manifold 36 of the reciprocating engine 20. Each of the EGR circuits 62 and 64 includes an EGR valve, such as EGR valves 84 and 86, configured to regulate the flow of exhaust gas back into the reciprocating engine 20 through the respective circuits 62 and 64. Downstream from the EGR valves, the EGR circuits 62 and 64 may include an EGR mixer, such as EGR mixers 88 and 90. The EGR mixers 88 and 90 are configured to mix the EGR flow (e.g., the exhaust gas) with the incoming air from the air intake section 46. The EGR mixers 88 and 90 mix the exhaust gas and air prior to delivery into the reciprocating engine 20 via the intake manifold 36. The EGR mixer 88 mixes the exhaust gas and air downstream from the compressor 58 of the turbocharger 54, whereas the EGR mixer 90 mixes the exhaust gas in the air upstream from the compressor 58 of the turbocharger 54. In certain embodiments, the combustion system 14 may include only one or both of the EGR circuits 62 and 64. In certain embodiments, the EGR circuits 62 and 64 and components contained therein may be omitted.

As further illustrated in FIG. 1, the combustion system 14 may include a control system 92 having a controller 94 coupled to a plurality of sensors 96 and actuators 98 distributed about the combustion system 14. For example, the sensors 96, designated as “S,” may be coupled to the combustion system 14 at various locations along the exhaust system 18, the intake system 40, the EGR circuit 62, the EGR circuit 64, the turbocharger 54, and the reciprocating engine 20. Each of these sensors 96 may be configured to measure one or more parameters of the combustion system 14, which may be collectively used by the controller 94 to control one or more aspects of the combustion system 14 based on the one or more parameters, as described in greater detail below. The actuators 98 may include valve actuators, such as valve actuators for the waste gate 74 and the bypass valve 76, valve actuators for the EGR valves 84 and 86, or any combination thereof.

The sensors 96 may include physical sensors and/or virtual sensors, which are configured to measure certain parameters of the combustion system 14. Accordingly, certain parameters may be measured directly via physical sensors and/or indirectly via virtual sensors. The monitored parameters may include a temperature, a pressure, a flow rate, and/or a composition of fluid (e.g., fuel, air, recirculated exhaust gas) flowing through the combustion system 14. For example, the monitored temperature and pressure data may correspond to one or more fuels (e.g., gaseous fuels and/or liquid fuels) temperature and/or pressure and/or an exhaust gas temperature and/or pressure flowing through the combustion system 14. Additionally or alternatively, the sensors 96 may include knock sensors and/or accelerometers configured to measure a vibration of the combustion system 14. The controller 94 may utilize the sensor data to control various aspects of the combustion system 14 (e.g., control a speed of the engine 20, control a position of one or more of the valves 74, 76 via operation of the actuators 98), as described in greater detail below.

The controller 94 may include one or processors 100, memory 102, instructions 104 stored on the memory 102 and executable by the processor 100, and communication circuitry 106 configured to communicate with the sensors 96, the actuators 98, and various components throughout combustion system 14. In certain embodiments, the controller 94 is configured to communicate with a human-machine interface and/or a portable computing device used by a technician to facilitate monitoring of the combustion system 14. For example, the controller 94 and/or the portable computing device may be configured to receive sensor feedback from the sensors 96, identify changes in monitored parameters, identify when thresholds are crossed for the parameters, and generate outputs to trigger changes in the operation of the reciprocating engine 20. The controller 94 and/or the portable computing device may use local and/or remote computer systems and storage, web-based interfaces, cloud-based interface, apps on smart devices (e.g., smart phones, tablet computers, etc.), or any suitable use interface to enable the changes in reciprocating engine 20. In certain embodiments, the controller 94 and/or the portable computing device may implement a cloud-based platform used for asset management of the reciprocating engine 20, such as myPlant, provided by INNIO Jenbacher GmbH & Co OG, Tyrol, Austria. As discussed in further detail below, the controller 94 may be configured to estimate fuel properties based on one or more control schemes and use the estimated fuel properties to control operation of the combustion system 14. As a result, the estimated fuel properties may improve the efficiency and performance of the controller 94, while also improving efficiency and performance of the combustion system 14.

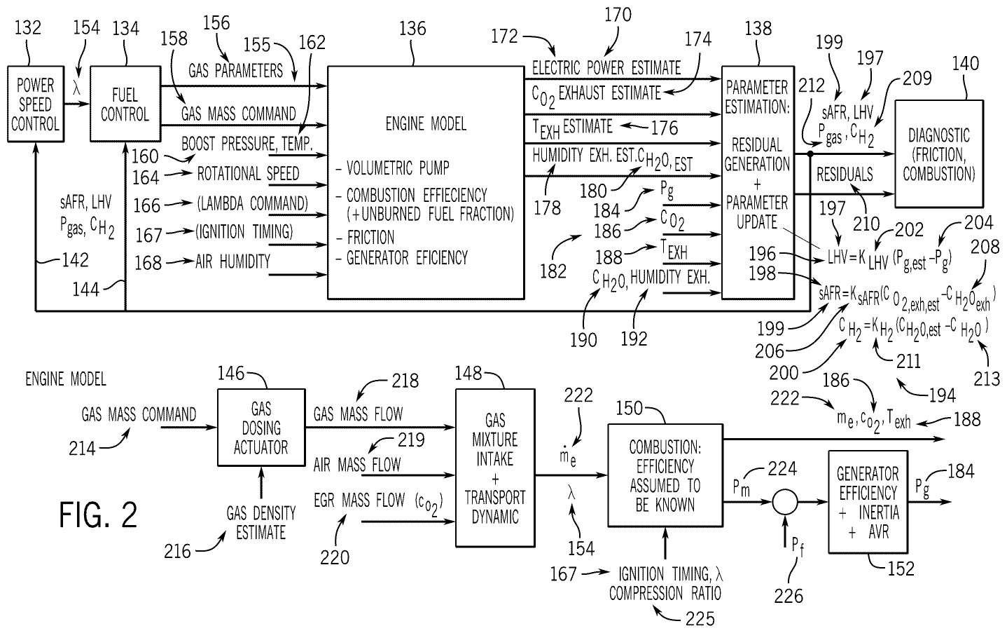

FIG. 2 is a block diagram of an embodiment of a first control scheme 130 executed by the controller 94 of the combustion system 14 of FIG. 1. In the illustrated embodiment, the first control scheme 130 uses adaptive control (e.g., model based adaptive control, direct adaptive control, indirect adaptive control). Additionally or alternatively, the first control scheme 130 may use robust control, proportional integral derivative (PID) control, stochastic control, or a combination thereof. In the illustrated embodiment, the first control scheme 130 includes a power control block 132 (e.g., speed control), a fuel control block 134, an engine model block 136 (e.g., plant), a parameter estimation block 138, and a diagnostic block 140. As shown, the first control scheme 130 includes a power control feedback loop 142 and a fuel control feedback loop 144. As shown, the engine model block 136 includes a gas dosing actuator block 146, a gas mixture intake block 148, a combustion block 150, and a generator efficiency block 152.

As shown, the power control block 132 outputs an excess air ratio 154 (λ) to the fuel control block 134. In the illustrated embodiment, the engine model block 136 receives a first plurality of input quantities 155. The first plurality of input quantities 155 includes a plurality of gas parameters 156 and a gas mass command 158 received by the engine model block 136 from the fuel control block 134. Additionally, the first plurality of input quantities 155 received by the engine model block 136 includes a boost pressure 160, a boost temperature 162, a rotation speed 164, a lambda command 166, an ignition timing 167, an air humidity 168, or a combination thereof. The use of the first plurality of input quantities 155 within the engine model block 136 is described in further detail herein.

As shown, the engine model block 136 outputs a plurality of output quantities 170, which includes an electric power estimate (P_{g.est}) 172, an exhaust oxygen concentration estimate (C_{O2,est}) 174, an exhaust temperature estimate (T_{exh.est}) 176, an exhaust humidity estimate 178 (e.g., water concentration estimate (C_{H2O,est}) 180), or a combination thereof. The plurality of output quantities 170 is received as inputs by the parameter estimation block 138. The parameter estimation block 138 additionally receives a second plurality of input quantities 182, which includes a measured generated power (P_{g}) 184, a measured exhaust oxygen concentration (C_{O2}) 186, a measured exhaust temperature (Tₑₓₕ) 188, a measured water concentration (C_{H2O}) 190 (e.g., a measured exhaust humidity 192), or a combination thereof.

As shown, the parameter estimation block 138 includes a system of differential equations 194, which includes a lower heating value (LHV) differential equation 196, a stoichiometric air fuel ratio (sAFR) differential equation 198, and a hydrogen concentration (CH) differential equation 200. The LHV differential equation 196 includes a first order time derivative of an LHV 197 on the left hand side, and an LHV update gain 202 (e.g., LHV parameter update gain) multiplied by a power residual 204 on the right hand side. The power residual 204 includes a difference between the electric power estimate 172 and the measured generated power 184. The sAFR differential equation 198 includes a first order time derivative of an sAFR 199 on the left hand side, and an sAFR update gain 206 (e.g., sAFR parameter update gain) multiplied by an oxygen concentration residual 208 on the right hand side. The oxygen concentration residual 208 includes a difference between the exhaust oxygen concentration estimate 174 and the estimated exhaust oxygen concentration 186. The hydrogen concentration (C_{H2}) differential equation 200 includes a first order time derivative of a hydrogen content 209 (e.g., hydrogen fraction) on the left hand side, and a hydrogen content update gain 211 (e.g., hydrogen content parameter update gain) multiplied by a water concentration residual 213. The water concentration residual 213 includes a difference between the water concentration estimate 180 and the measured water concentration 190.

In the illustrated embodiment, the system of differential equations 194 includes linear, first order, and ordinary differential equations. In certain embodiments, the system of differential equations 194 may include non-linear, higher order, and/or differential equations with more than one independent variable. For example, in certain embodiments, the LHV update gain 202, the sAFR update gain 206, and/or the hydrogen content update gain 204 may be time variant variables. As discussed in further detail herein, the system of differential equations 194 may be provided with initial estimates for the LHV 197, the sAFR 199, and the hydrogen content 209 to form an initial value problem. The initial value problem may be solved using a solver using one or more differential equation solving algorithms. For example, the initial value problem may be solved using Euler's method, Runge Kutta, or any suitable combination of methods for solving systems of differential equations.

As shown, a plurality of residuals 210 (e.g., power residual 204, oxygen concentration residual 208, water concentration residual 213), along with the LHV 197, sAFR 199, the hydrogen content 209, and a gas density 212 are output by the parameter estimation block 138 to the diagnostic block 140. As shown, the LHV 197, sAFR 199, the hydrogen content 209, and the gas density 212 are fed back to the power control block 132 and/or the fuel control block 134. As shown indicated in the illustrated embodiment, the LHV 197, sAFR 199, the hydrogen content 209, and/or the gas density 212 may be used for adjust gains and/or variables in the power control block 132 and/or the fuel control block 134.

In the illustrated embodiment, the gas dosing actuator block 146 of the engine model block 136 receives a gas mass command 214 and a gas density estimate 216, and outputs a gas mass flow 218 to the gas mixture intake block 148. The gas mixture intake block 148 additionally receives an air mass flow 219 and an EGR mass flow 220 (e.g., estimated exhaust oxygen concentration 186). The gas mixture intake block 148 outputs an estimated engine mass flow 222 and the excess air ratio 154 to the combustion block 150. Various methods for determining the estimated engine mass flow 222 are discussed in further detail herein. The combustion block 150 additionally receives the ignition timing 167 and a compression ratio 225.

As shown the combustion block 150 outputs the estimated engine mass flow 222, the estimated exhaust oxygen concentration 186, and the estimated exhaust temperature 188. Additionally, the combustion block 150 outputs an estimated mechanical power 224, which is summed with a friction power loss 226 before being received by the generator efficiency block 152. As shown, the generator efficiency block 152 outputs the measured generated power 184. In certain embodiments, the estimated exhaust oxygen concentration 186, the estimated exhaust temperature 188, and the measured generated power 184 are fed directly to the parameter estimation block 138.

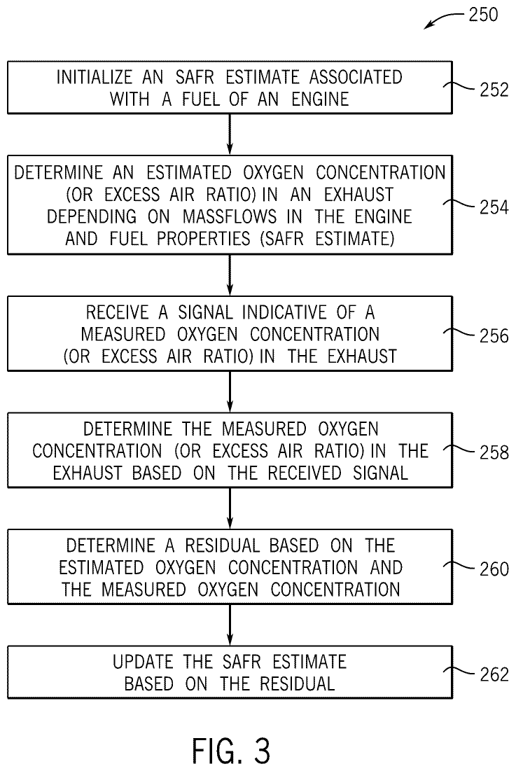

FIG. 3 is a flow chart of an embodiment of a process 250 for updating a stoichiometric air fuel ratio (sAFR) estimate. The process 250 may be performed using the first control scheme 130 shown in FIG. 2 implemented on the controller 94 in FIG. 1. In certain embodiments, the process 250 may be performed using other suitable control systems and/or computing device(s) or controller(s). Furthermore, the blocks of the process 250 may be performed in the order disclosed herein or in any other suitable order. For example, certain blocks of the process 250 may be performed concurrently. In addition, in certain embodiments, at least one of the blocks of the process 250 may be omitted. In certain embodiments, the process 250 may be stored on a tangible, non-transitory, computer-readable medium that, when executed by suitable control systems and/or computing device(s), may cause an electronic device to execute the process 250 described herein.

In block 252 of the process 250, the one or more processors of the controller initialize a sAFR estimate. In certain embodiments, the initial sAFR estimate may be determined based on one or more operating parameters (e.g., conditions) of the engine. For example, the initial sAFR estimate may be based on one or more signals received from one or more sensors, such as a fuel flow rate, an air flow rate, temperature, humidity, and the like. In certain embodiments, the initialized sAFR estimate may be based on a type of fuel used in the engine. For example, the fuel may be composed of methane (CH₄) and hydrogen (H₂), or CH₄ and a diluent. In certain embodiments, the fuel may include more than two constituents.

In block 254 of the process 250, the one or more processors of the controller estimate an oxygen concentration in the exhaust (C_{O2,ext}) based on a model. The model may estimate an engine mass flow based on the following equation:

$${\dot{m}}_{e , est} = \frac{{η}_{vol} {V}_{d} ω {p}_{im}}{4 π {R}_{im} {T}_{im}}$$

In the above equation and as used throughout, \dot{m}_{e,est} is the estimated engine mass flow, ηᵥₒₗ is the volumetric efficiency, V_{d} is the displacement volume, ω is the engine speed, pᵢₘ is the intake manifold pressure, Rᵢₘ is the specific gas constant in the intake manifold, and Tᵢₘ is the intake manifold temperature. The estimated engine mass flow and the sAFR estimate are used to determine a gas mass flow estimate. In certain embodiments, the gas mass flow estimate may be determined using the actual commanded gas mass flow according to the following equation:

$${\dot{m}}_{gas , est} = {\dot{m}}_{gas , cmd} = {\dot{m}}_{e , est} \frac{1}{1 + {u}_{λ} sAFR}$$

In the above equation, \dot{m}_{gas,est} is the estimated gas mass flow in the cylinders, \dot{m}_{gas,cmd} is the commanded gas in the cylinders, u_{λ} is the commanded excess air ratio (e.g., air-fuel equivalence ratio), and sAFR is the sAFR estimate. In certain embodiments, the gas mass flow estimate may be determined using the following delayed mass flow equation:

$${\dot{m}}_{gas , est} = {\dot{m}}_{e , est} ( t - D )$$

In the above equation, t is the current time step (e.g., clock time) and D is a gas dosage delay. In certain embodiments, the gas mass flow estimate may be determined using the following delayed lambda equation:

$${\dot{m}}_{gas , est} = {\dot{m}}_{e , est} \frac{1}{1 + λ sAFR}$$

In the above equation, λ is the excess air ratio, or the actual air-fuel ratio (AFR) involved in combustion divided by the stoichiometric air-fuel ratio. In certain embodiments, λ may be measured and/or estimated based on fuel commands. In certain embodiments, the air mass flow estimate at the cylinders may be estimated based on the gas mass flow estimate and either of the following differential equations or a combination thereof:

$${\dot{m}}_{air , est} = {\dot{m}}_{e , est} - {\dot{m}}_{gas , est}$$

$${\dot{m}}_{air , est} = {\dot{m}}_{gas , est} λ sAFR$$

In the above equations, \dot{m}_{air,est} is the air mass flow at the cylinders. Using the gas mass flow estimate and/or the air mass flow estimate, the air mass flow after combustion estimate (e.g., exhaust mass flow estimate) may be determined using either of the following differential equations or a combination thereof:

$${\dot{m}}_{air , exh , est} = {\dot{m}}_{air , est} - {\dot{m}}_{gas , est} sAFR$$

$${\dot{m}}_{air , exh , est} = ( λ - 1 ) sAFR {\dot{m}}_{gas , est}$$

In the above equations, \dot{m}_{air,exh,est} is the air mass flow after combustion estimate. The air mass flow after combustion estimate and the engine mass flow estimate are used to determine an estimated oxygen content (e.g., oxygen fraction) of the exhaust using the following equation:

$${c}_{{O}_{2} , exh , est} = \frac{{\dot{m}}_{air , exh , est}}{{\dot{m}}_{e , est}} {c}_{{O}_{2} , Air}$$

In the above equation, c_{O}_{₂}_{,Air} is an estimated (e.g., measured) concentration of oxygen in the air, and c_{O}_{₂}_{,exh,est} is the estimated oxygen content of the exhaust. In certain embodiments, the concentration of oxygen in the air may be measured using a sensor.

In block 256 of the process 250, the one or more processors of the controller receive a signal indicative of a measured oxygen concentration in the exhaust (c_{O}_{₂}_{,exh}) from one or more sensors. In certain embodiments, the one or more sensors may be located in the exhaust of the engine or in other locations of the engine. In certain embodiments, the signal may include an aggregate of a plurality of sensor measurements. In block 258 of the process 250, the measured oxygen concentration in the exhaust is determined (e.g., via the controller) based on the received signal. In certain embodiments, the excess air ratio (λ) may be used to determine the measured oxygen concentration in the exhaust.

In block 260 of the process 250, the one or more processors of the controller determine the oxygen concentration residual based on the estimated oxygen content in the exhaust and the measured oxygen content in the exhaust, according to the following equation:

$${R}_{sAFR} = {c}_{{O}_{2} , exh , est} - {c}_{{O}_{2} , exh}$$

In the above equation, R_{sAFR} is the oxygen concentration residual (e.g., residuum). In certain embodiments, the oxygen concentration residual may also be approximated by taking a difference between an estimated and measured excess air ratio. The estimated excess air ratio may be determined using the following equation:

$${\dot{λ}}_{est} = \frac{1}{{T}_{λ}} ( {u}_{λ} ( t - D ) - {λ}_{est} )$$

In the above equation, Jest is the estimated excess air ratio, and T_{λ} is a mixing time constant of the fuel. In certain embodiments, one or more sensors may be used to receive a signal indicative a measured excess air ratio. Accordingly, in certain embodiments, the oxygen concentration residual may be approximated using the following equation:

$${R}_{sAFR} = {λ}_{est} - {λ}_{measured}$$

In the above equation, λ_{measured} is the measured excess air ratio. In block 262 of the process 250, the sAFR may be updated using the following first order differential equation:

$$\dot{sAFR} = {K}_{sAFR} {R}_{sAFR}$$

In the above equation, sAFR is the first order time derivative of sAFR and K_{sAFR} is the stochiometric air fuel ratio update gain (e.g., learning rate). As discussed herein, the above differential equation was provided with an initial condition in block 252 to form an initial value problem. In certain embodiments, after the sAFR is updated using the above differential equation, the process 250 repeats starting at block 254. That is, blocks 254-262 may be repeated so that the oxygen concentration residual is minimized.

In certain embodiments, the process 250 includes adjusting a power controller of the engine system, a speed controller (e.g., rotational speed controller) of the engine system, a torque controller of the engine system, or a combination thereof based on the updated sAFR. For example, the process 250 may include updating parameters of a model based controller, updating gains of a proportional integral derivative (PID) controller, or a combination thereof, based on the updated sAFR. In certain embodiments, the process 250 may include adjusting a boost pressure setpoint, an air fuel equivalence ratio setpoint, an ignition time setpoint, or a combination thereof, based on the updated sAFR. Additionally or alternatively, the process 250 may include adjusting air fuel equivalence ratio limits, knock/misfire limits, or a combination thereof, based on the updated sAFR. In certain embodiments, the process 250 includes determining one or more concentrations of one or more constituents of the fuel based on the updated sAFR.

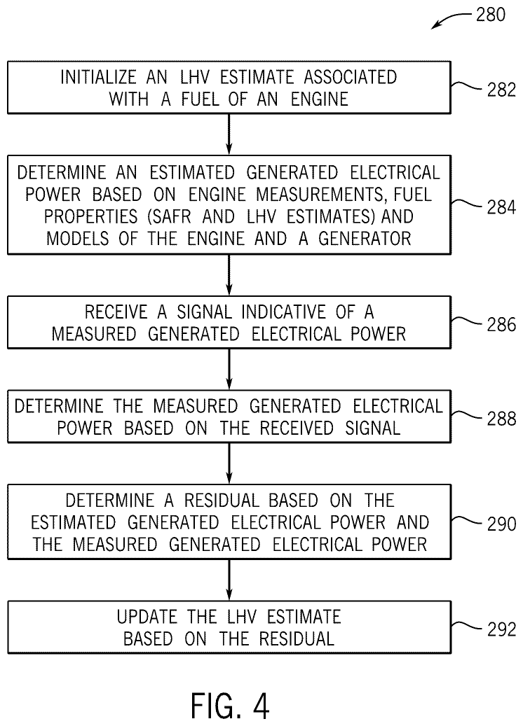

FIG. 4 is a flow chart of an embodiment of a process 280 for updating a lower heating value (LHV) estimate. The process 280 may be performed using the first control scheme 130 shown in FIG. 2 implemented on the controller 94 in FIG. 1. In certain embodiments, the process 280 may be performed using other suitable control systems and/or computing device(s) or controller(s). Furthermore, the blocks of the process 280 may be performed in the order disclosed herein or in any other suitable order. For example, certain blocks of the process 280 may be performed concurrently. In addition, in certain embodiments, at least one of the blocks of the process 280 may be omitted. In certain embodiments, the process 280 may be stored on a tangible, non-transitory, computer-readable medium that, when executed by suitable control systems and/or computing device(s), may cause an electronic device to execute the process 280 described herein.

In block 282 of the process 280, the one or more processors of the controller initialize an LHV estimate. In certain embodiments, the initial LHV estimate may be determined based on one or more operating parameters (e.g., conditions) of the engine. For example, the initial LHV estimate may be based on one or more signals received from one or more sensors, such as fuel flow rate, fuel mass flow rate, temperature, humidity, and the like. In certain embodiments, the initialized LHV estimate may be based on a type of fuel used in the engine. For example, the fuel may be composed of methane (CH₄) and hydrogen (H₂), or CH₄ and a diluent. In certain embodiments, the fuel may include more than two constituents.

In block 284 of the process 280, the one or more processors of the controller determine a generated electric power (e.g., generated by a generator driven by the engine) estimate based on a model. Additionally or alternatively, a generated engine torque may be used. The model may first estimate an engine mass flow based on the following equation:

$${\dot{m}}_{e , est} = \frac{{η}_{vol} {V}_{d} ω {p}_{im}}{4 π {R}_{im} {T}_{im}}$$

In the above equation and as used throughout, \dot{m}_{e,est} is the estimated engine mass flow, ηᵥₒₗ is the volumetric efficiency, V_{d} is the displacement volume, ω is the engine speed, pᵢₘ is the intake manifold pressure, Rᵢₘ is the specific gas constant in the intake manifold, and Tᵢₘ is the intake manifold temperature. The estimated engine mass flow and the sAFR (e.g., from FIG. 3) are used to determine a gas mass flow estimate. In certain embodiments, the gas mass flow estimate may be determined using the actual commanded gas mass flow according to the following equation:

$${\dot{m}}_{gas , est} = {\dot{m}}_{gas , cmd} = {\dot{m}}_{e , est} = \frac{1}{1 + {u}_{λ} sAFR}$$

In the above equation, \dot{m}_{gas,est} is the estimated gas mass flow in the cylinders, \dot{m}_{gas,cmd} is the commanded gas in the cylinders, u_{λ} is the commanded excess air ratio (e.g., air-fuel equivalence ratio), and sAFR is the sAFR estimate. In certain embodiments, the gas mass flow estimate may be determined using the following delayed mass flow equation:

$${\dot{m}}_{gas , est} = {\dot{m}}_{e , est} ( t - D )$$

In the above equation, t is the current time step (e.g., clock time) and D is a gas dosage delay. In certain embodiments, the gas mass flow estimate may be determined using the following delayed lambda equation:

$${\dot{m}}_{gas , est} = {\dot{m}}_{e , est} \frac{1}{1 + λ sAFR}$$

In the above equation, λ is the excess air ratio, or the actual air-fuel ratio (AFR) involved in combustion divided by the stoichiometric air-fuel ratio. In certain embodiments, λ may be measured and/or estimated based on fuel commands. The generated engine mechanical power estimate may be determined using the following equation:

$${P}_{m , est} = {\dot{m}}_{gas , est} LHV {η}_{c} - {P}_{f}$$

In the above equation, P_{m,est} is the generated engine mechanical power estimate, LHV is the lower heating value (e.g., updated lower heating value), η_{c} is the combustion efficiency, and P_{f} is the friction power loss. The generated electric power may be determined according to the following equation:

$${P}_{g , est} = {P}_{m , est} {η}_{g}$$

In the above equation, η_{g} is the generator efficiency. In block 286 of the process 280, a signal indicative of a measured generated electric power may is received by the controller from one or more sensors. For example, one or more sensors may be configured to provide the controller with a quantity indicative of a generated electric power. In block 288 of the process 280, the controller determines the measured generated electric power based on the received signal.

In block 290 of the process 280, the one or more processors of the controller determine the power residual based on the estimated generated electric power and the measured generated electric power. The power residual may be determined based on the following equation:

$${R}_{LHV} = {P}_{g , est} - {P}_{g}$$

In the above equation, R_{LHV} is the power residual (e.g., residuum) and P_{g} is the measured generated electric power. In block 292 of the process 280, the LHV may be updated based on the power residual based on the following equation:

$$L \dot{H} V = {K}_{LHV} {R}_{LHV}$$

In the above equation, L\dot{H}V is the first time derivative of the LHV and K_{LHV} is the lower heating value update gain (e.g., learning rate). As discussed herein, the above differential equation was provided with an initial condition in block 282 to form an initial value problem. In certain embodiments, after the LHV is updated using the above differential equation, the process 280 repeats starting at block 284. That is, blocks 284-292 may be repeated so that the power residual is minimized.

In certain embodiments, the process 280 includes adjusting a power controller of the engine system, a speed controller (e.g., rotational speed controller) of the engine system, a torque controller of the engine system, or a combination thereof, based on the updated LHV. For example, the process 280 may include updating parameters of a model based controller, updating gains of a proportional integral derivative (PID) controller, or a combination thereof, based on the updated LHV. In certain embodiments, the process 280 may include adjusting a boost pressure setpoint, an air fuel equivalence ratio setpoint, an ignition time setpoint, or a combination thereof, based on the updated LHV. Additionally or alternatively, the process 280 may include adjusting air fuel equivalence ratio limits, knock/misfire limits, or a combination thereof, based on the updated LHV. In certain embodiments, the process 280 includes determining one or more concentrations of one or more constituents of the fuel based on the updated LHV.

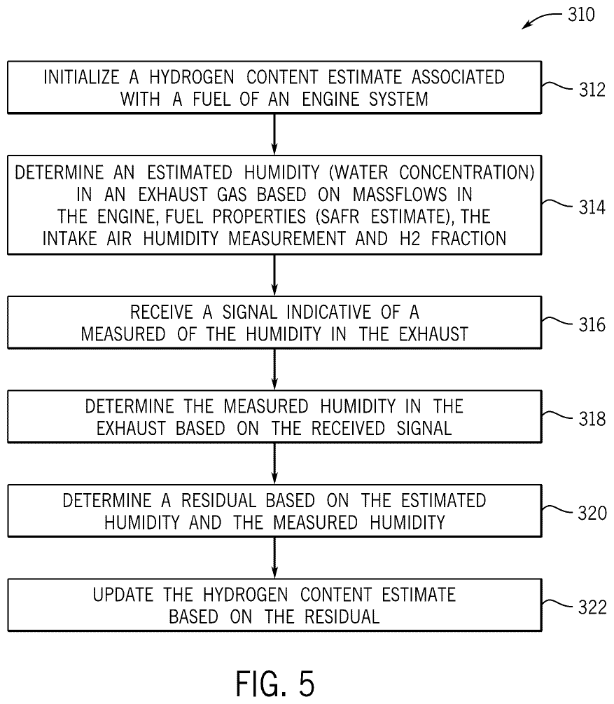

FIG. 5 is a flow chart of an embodiment of a process 310 for updating a hydrogen (H₂) content (e.g., hydrogen fraction, etc.) estimate. The process 310 may be performed using the first control scheme 130 shown in FIG. 2 implemented on the controller 94 in FIG. 1. In certain embodiments, the process 310 may be performed using other suitable control systems and/or computing device(s) or controller(s). Furthermore, the blocks of the process 310 may be performed in the order disclosed herein or in any other suitable order. For example, certain blocks of the process 310 may be performed concurrently. In addition, in certain embodiments, at least one of the blocks of the process 310 may be omitted. In certain embodiments, the process 310 may be stored on a tangible, non-transitory, computer-readable medium that, when executed by suitable control systems and/or computing device(s), may cause an electronic device to execute the process 310 described herein.

In block 312 of the process 310, the one or more processors of the controller initialize a hydrogen content estimate. In certain embodiments, the initial hydrogen content estimate may be determined based on one or more operating parameters (e.g., conditions) of the engine, a value entered by an operator, and/or a value stored in nonvolatile memory from the most recent engine shutdown. For example, the initial hydrogen content estimate may be based on one or more signals received from one or more sensors, such as temperature (e.g., in the exhaust), humidity (e.g., in the exhaust), air mass flow (e.g., in the exhaust), air mass flow (e.g., at the cylinders) and the like.

In block 314 of the process 310, the one or more processors of the controller determine an estimated water concentration (e.g., humidity) in the exhaust gas based on a model. In certain embodiments, the model may include a lookup table and/or graph that relates hydrogen content of the fuel to water concentration in the exhaust. In certain embodiments, the estimated water concentration is based on the sAFR and/or the excess air ratio.

In block 316 of the process 310, the one or more processors of the controller receive a signal indicative of a measured water concentration in the exhaust. In certain embodiments, the signal may be received by the controller from one or more sensors configured to provide a signal indicative of water concentration. In block 318 of the process 310, the measured water concentration in the exhaust is determined based on the received signal.

In block 320 of the process 310, the one or more processors of the controller determine the water concentration residual based on the estimated water concentration in the exhaust and the measured water concentration in the exhaust. In certain embodiments, the water concentration residual may be determined based on the following equation:

$${R}_{H 2 O} = {c}_{{H}_{2} O , est} = {c}_{{H}_{2} O}$$

In the above equation, R_{H2O} is the water concentration residual (e.g., residuum), C_{H}_{₂}_{O,est} is the estimated water concentration in the exhaust, and C_{H}_{₂}_{O} is the measured water concentration in the exhaust.

In block 322 of the process 310, the one or more processors of the controller update the hydrogen content (e.g., fraction) of the fuel based on the water concentration residual. In certain embodiments, the hydrogen content may be updated based on the following equation:

$${\dot{c}}_{{H}_{2}} = {K}_{{H}_{2}} {R}_{H 2 O}$$

In the above equation, ċ_{H}_{₂} is the first time derivative of the hydrogen content and K_{H}_{₂} is the hydrogen content update gain (e.g., learning rate).

Additionally or alternatively, the one or more processors of the controller may update an exhaust temperature estimate based on the determined hydrogen content. For example, the controller may use a model and/or a lookup table to estimate the exhaust temperature based on one or more engine measurements (e.g., load, boost pressure, boost temperature), estimated gas parameters, and the actual estimated hydrogen fraction (C_{H}_{₂}). In certain embodiments, an exhaust temperature residual may be determined based on the following equation:

$${R}_{{T}_{exh}} = {T}_{exh , est} - {T}_{exh}$$

In the above equation, R_{T}_{ₑₓₕ} is the residuum of the exhaust temperature, T_{exh,est} is the estimated exhaust temperature, and Tₑₓₕ is the actual exhaust temperature. In certain embodiments, the controller may determine the hydrogen content C_{H}_{₂} in order to minimize the residuum of the exhaust temperature, R_{T}_{ₑₓₕ}.

As discussed herein, the above differential equation was provided with an initial condition in block 312 to form an initial value problem. In certain embodiments, after the hydrogen content is updated using the above differential equation, the process 310 repeats starting at block 314. That is, blocks 314-322 may be repeated so that the water concentration residual is minimized.

In certain embodiments, the process 310 includes adjusting a power controller of the engine system, a speed controller (e.g., rotational speed controller) of the engine system, a torque controller of the engine system, or a combination thereof, based on the updated hydrogen content. For example, the process 310 may include updating parameters of a model based controller, updating gains of a proportional integral derivative (PID) controller, or a combination thereof, based on the updated hydrogen content. In certain embodiments, the process 310 may include adjusting a boost pressure setpoint, an air fuel equivalence ratio setpoint, an ignition time setpoint, or a combination thereof, based on the updated hydrogen content. Additionally or alternatively, the process 310 may include adjusting air fuel equivalence ratio limits, knock/misfire limits, or a combination thereof, based on the updated hydrogen content. In certain embodiments, the process 310 includes determining one or more concentrations of one or more constituents of the fuel based on the updated hydrogen content.

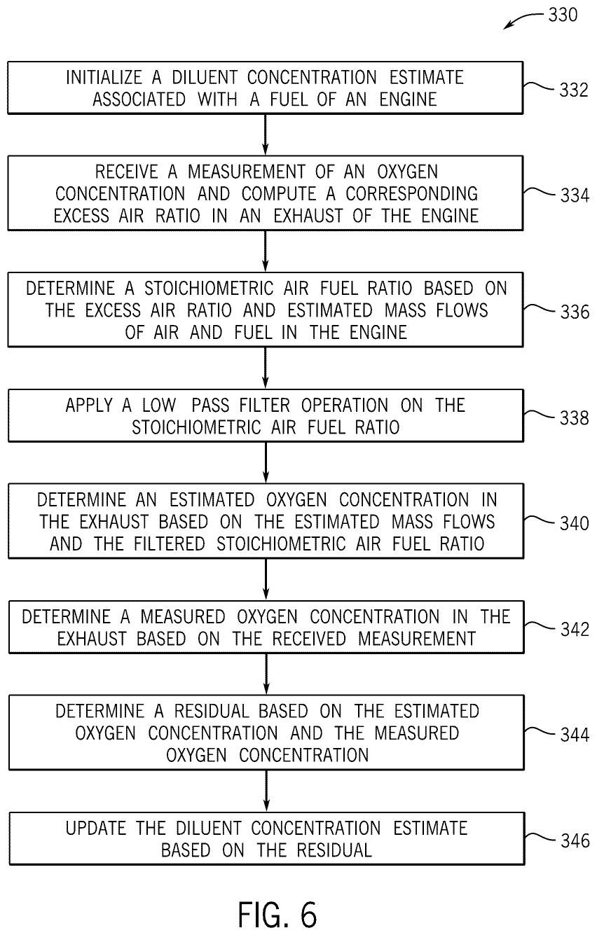

FIG. 6 is a flow chart of an embodiment of a process 330 for updating a diluent concentration estimate. The process 330 may be performed using the first control scheme 130 shown in FIG. 2 implemented on the controller 94 in FIG. 1. In certain embodiments, the process 330 may be performed using other suitable control systems and/or computing device(s) or controller(s). Furthermore, the blocks of the process 330 may be performed in the order disclosed herein or in any other suitable order. For example, certain blocks of the process 330 may be performed concurrently. In addition, in certain embodiments, at least one of the blocks of the process 330 may be omitted. In certain embodiments, the process 330 may be stored on a tangible, non-transitory, computer-readable medium that, when executed by suitable control systems and/or computing device(s), may cause an electronic device to execute the process 330 described herein.

In block 332 of the process 330, the one or more processors of the controller initialize a diluent concentration estimate. In certain embodiments, the initial diluent concentration estimate may be determined based on one or more operating parameters (e.g., conditions) of the engine, a value entered by an operator, and/or a value stored in nonvolatile memory from the most recent engine shutdown. For example, the initial diluent concentration estimate may be based on one or more signals received from one or more sensors, such as temperature (e.g., in the exhaust), humidity (e.g., in the exhaust), air mass flow (e.g., in the exhaust), air mass flow (e.g., at the cylinders) and the like.

In block 334 of the process 330, the one or more processors of the controller determine a measured excess air ratio (λₘ). In certain embodiments, the initial measured excess air ratio may be determined based on one or more operating parameters (e.g., conditions) of the engine, a value entered by an operator, and/or a value stored in nonvolatile memory from the most recent engine shutdown. In certain embodiments, the measured excess air ratio is initialized based on a measured oxygen concentration (C_{O}_{²}_{,exh}) received from an oxygen sensor disposed in the exhaust.

In block 336 of the process 330, the one or more processors of the controller determine an sAFR estimate based on the measured excess air fuel ratio and the estimated mass flows of air and fuel in the engine. The controller may estimate an engine mass flow based on the following equation:

$${\dot{m}}_{e , est} = \frac{{η}_{vol} {V}_{d} ω {p}_{im}}{4 π {R}_{im} {T}_{im}}$$

In the above equation and as used throughout, \dot{m}_{e,est} is the estimated engine mass flow, ηᵥₒₗ is the volumetric efficiency, V_{d} is the displacement volume, ω is the engine speed, pᵢₘ is the intake manifold pressure, Rᵢₘ is the specific gas constant in the intake manifold, and Tᵢₘ is the intake manifold temperature. The estimated engine mass flow and the sAFR estimate are used to determine a gas mass flow estimate. In certain embodiments, the gas mass flow estimate may be determined using the actual commanded gas mass flow according to the following equation:

$${\dot{m}}_{gas , est} = {\dot{m}}_{gas , cmd}$$

In the above equation, \dot{m}_{gas,est} is the estimated gas mass flow in the cylinders, \dot{m}_{gas,cmd} is the commanded gas in the cylinders. In certain embodiments, the air mass flow estimate at the cylinders may be estimated based on the gas mass flow estimate and either of the following differential equations or a combination thereof:

$${\dot{m}}_{air , est} = {\dot{m}}_{e , est} - {\dot{m}}_{gas , est}$$

In the above equation, \dot{m}_{air,est} is the air mass flow at the cylinders. The sAFR estimate may be determined based on the measured excess air ratio, the estimated gas mass flow, and the air mass flow at the cylinders, or a combination thereof according to the following equation:

$${sAFR}_{act} = \frac{\frac{{\dot{m}}_{air , est}}{{m}_{gas , est}}}{{λ}_{m}}$$

$$sAFR = {sAFR}_{act} \frac{1}{Ts + 1}$$

In block 338 of the process 330, as shown in the above equation, a low pass filter operation, designated by

$$\frac{1}{Ts + 1} ,$$

may be applied to sAPR_{act} to obtain the estimated sAFR, designated by sAFR. In the above equation, T is a time constant and s is the Laplace transform variable.

In block 340 of the process 330, the controller may determine an estimated oxygen concentration in the exhaust based on the mass flows in the engine and the sAFR estimate. An air mass flow after combustion may be determined based on either of the following equations:

$${\dot{m}}_{air , exh , est} = {\dot{m}}_{air , est} - {\dot{m}}_{gas , est} sAFR$$

$${\dot{m}}_{air , exh , est} = ( {λ}_{m} - 1 ) sAFR {\dot{m}}_{gas , est}$$

In the above equations, \dot{m}_{air,exh,est} is the air mass flow after combustion estimate. The air mass flow after combustion may be used to determine the estimated oxygen concentration in the exhaust based on the following equation:

$${c}_{{O}_{2} , exh , est} = \frac{{\dot{m}}_{air , exh , est}}{{\dot{m}}_{e , est}} {c}_{{O}_{2} , Air}$$

In the above equation, c_{O}_{₂}_{,exh,est} is the estimated oxygen concentration in the exhaust and c_{O}_{₂}_{,Air} is the oxygen concentration (e.g., oxygen fraction) of the ambient air. In block 342 of the process 330, the controller may receive a measured oxygen concentration in the exhaust (e.g., from a sensor disposed in the exhaust).

In block 344 of the process 330, the controller may compute the residual between the estimated oxygen concentration in the exhaust and the measured oxygen concentration in the exhaust according to the following equation:

$$R = {c}_{{O}_{2} , exh , est} - {c}_{{O}_{2} , exh}$$

In the above equation, R is the residuum of the oxygen concentration in the exhaust, and c_{O}_{₂}_{,exh} is the measured oxygen concentration. In block 346 of the process 330, the controller may update the diluent concentration in order to minimize the residuum R according to the following equation:

$${\dot{c}}_{diluent} = {K}_{diluent} R$$

In the above equation, ċ_{diluent} is the first time derivative of the diluent concentration and K_{diluent} is the diluent concentration update gain (e.g., learning rate).

Additionally, it may be recognized that the processes disclosed in FIGS. 3-6 may be described as a generic process. The generic process may initialize an estimated fuel property associated with a fuel of an engine system. The generic process may also determine an estimated quantity associated with operation of the engine based on a model. The generic process may also receive a signal indicative of a measured quantity corresponding to the estimated quantity. The generic process may also determine the measured quantity based on the received signal. The generic process may also determine a residual based on the estimated quantity and the measured quantity. The generic process may also update the estimated fuel property based on the residual.

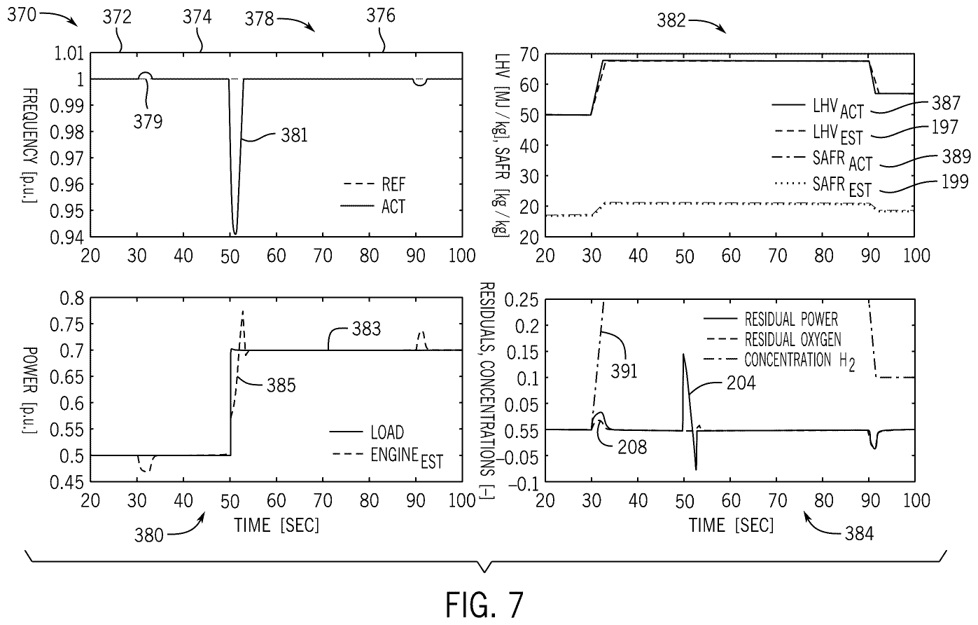

FIG. 7 is a series of simulation plots 370 showing the system response of the first control scheme 130 of FIG. 2 to changes in input. In the simulation, the engine was commanded to operate at a constant speed. At a first time 372 (e.g., t=30 sec), the hydrogen fraction is increased to 25%. At a second time 374 (e.g., t=50 sec), the load of the engine is changed from 50% to 70%. At a third time 376 (e.g., t=90 sec), the hydrogen fraction is decreased to 10%. It may be recognized that the processes 250, 280, 310, and 340 as described in FIGS. 3-6 herein are active during this simulation.

As shown, a first plot 378 shows a reference engine speed 379 and an actual engine speed 381 observed during the simulation. As shown, actual engine speed 381 tracks the reference engine speed 379 (e.g., setpoint engine speed) fairly well, but decreases slightly at the second time 374 due to the increase in load. The change in the hydrogen at the first time 372 and the third time 376 result in a slight engine speed error.

As shown, a second plot 380 shows a commanded engine load 383 and an estimated engine load 385. As shown, the estimated engine load 385 tracks the commanded engine load 383, but overshoots slightly at the second time 374 when the commanded engine load 383 is changed. Additionally, the estimated engine load 385 displays some small error at the first time 372 and the third time 376 when the hydrogen fractions are changed.

As shown, a third plot 382 shows an actual lower heating value 387 and the estimated lower heating value 197, as well as an actual stoichiometric air fuel ratio 389 and the estimated stoichiometric air fuel ratio 199. As shown, the estimated lower heating 197 value closely tracks the actual lower heating value 387, and the estimated stoichiometric air fuel ratio 199 closely tracks the actual (e.g. measured) stoichiometric air fuel ratio 389.

As shown, a fourth plot 384 shows the residual power 204, the residual oxygen concentration 208, and a commanded hydrogen concentration 391. As shown, the residual power 204 and the residual oxygen concentration 208 remain fairly small throughout the duration. The residual power 204 reached approximately 0.15 at the second time 374 of the engine load step input, whereas the residual oxygen concentration 208 did not respond to the change in engine load. The residual oxygen concentration 208 and the residual power 204 changed slightly in response to the change of the commanded hydrogen concentration 391 at the first time 372 and the third time 376.

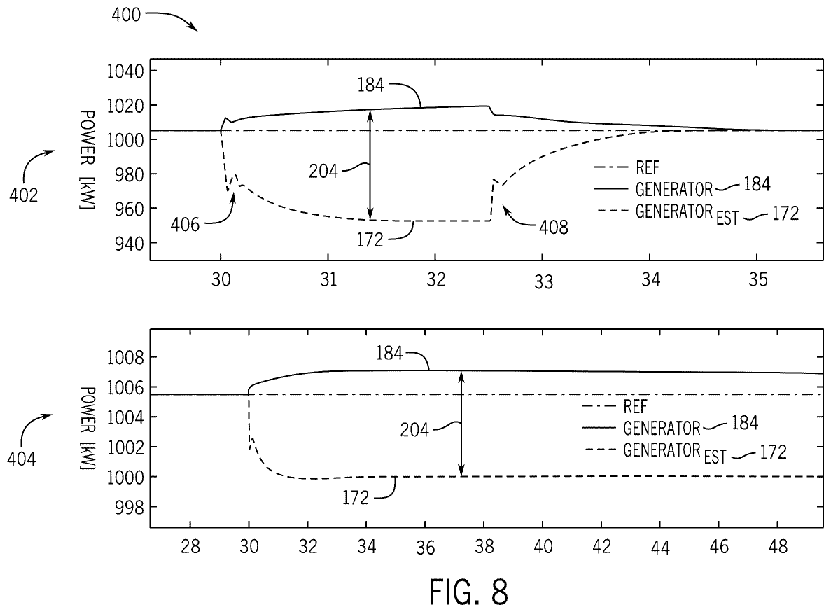

FIG. 8 is a series of graphs 400 (e.g., graphs 402 and 404) showing the electric power estimate 172 and the measured generated power 184 that may be used for diagnosing a type of failure mode. In the first graph 402, there is a large deviation between the electric power estimate 172 and the measured generated power 184. As shown, the residual power 204 is the difference between the electric power estimate 172 and the measured generated power 184. In the first graph 402, the differential of the residual power 204 is high a locations 406 and 408. It may be appreciated that a fast change in a derivative of the residual power 204 may be indicative of a friction event occurring in the engine. In the second graph 404, although there is a deviation between the electric power estimate 172 and the measured generated power 184, the derivative of the residual power 204 is fairly constant over time and changes gradually. It may be recognized that a gradual change in the derivative of the residual power, as shown in the second graph 404, may be indicative of a change in the gas quality over time.

Additionally or alternatively, a comparison may be made between changes in the estimated stoichiometric air fuel ratio (e.g., indicated by L_{min, est} in the following table) and changes in the estimated lower heating value (e.g., indicated by H_{i,est} in the following table). In normal operations, the change of the estimated lower heating value is aligned with the change in the estimated stoichiometric air fuel ratio. In instances where changes in these values are not aligned, the controller may predict a failure mode and/or a root cause based on the following table relating changes in the estimated lower heating value, the estimated stoichiometric air fuel ratio, and the electric power estimate:

| Hᵢ est | Lₘᵢₙ est | Power | Interpretation | Root cause | Failure mode |
|---|---|---|---|---|---|
| Increase | Increase | | Fuel contains more | H2 fraction | None, expected |
| | | | energy and requires | increase or inert | |
| | | | more oxygen | fraction decrease | |
| Decrease | Decrease | | Fuel contains less | H2 fraction | None, expected |
| | | | energy and requires | decrease or inert | |
| | | | less oxygen | fraction increase | |
| Decrease | Constant/ | constant | Estimated power | Friction increase | Friction |
| | increase | | higher than | of engine | |
| | | | measured, lost | components | |
| | | | energy | | |
| Decrease | Constant/ | loss | Estimated power | Combustion | Misfire |
| | increase | | higher than | irregularity - | |
| | | | measured, lost | misfire | |
| | | | energy | | |
| Increase | Constant/ | | Estimated power | Irregular | Combustion issue |
| | decrease | | lower than | combustion | |
| | | | measured, additional | (glow ignition) | |
| | | | energy | or new source of | |
| | | | | energy - e.g. oil | |

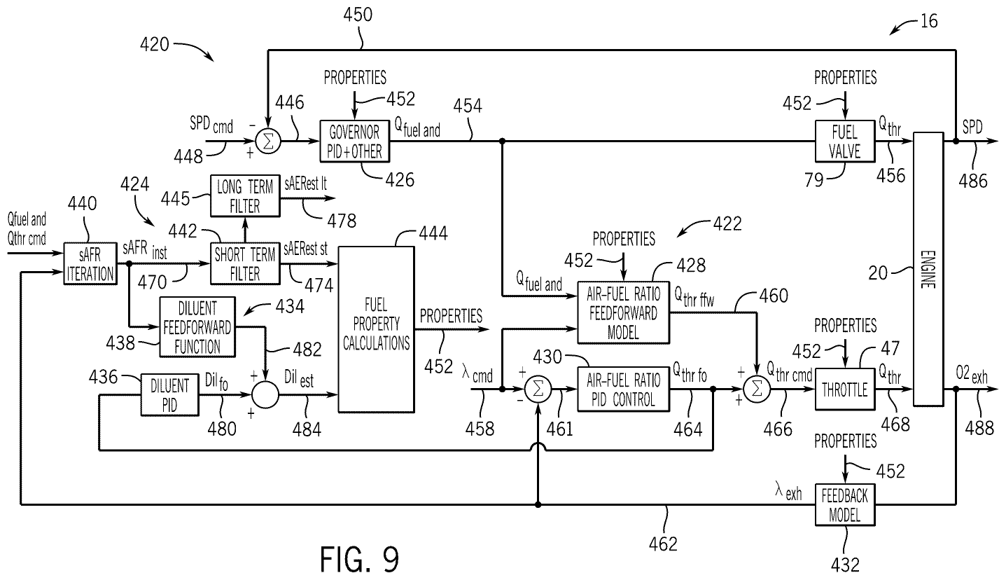

FIG. 9 is a block diagram of an embodiment of a second control scheme 420 (e.g., control logic, controller) executed by the controller 94 of the combustion system 14 of FIG. 1. In the illustrated embodiment, the second control scheme 420 includes the engine system 16 having the one or more engines 20. As shown, the engine system 16 also includes the fuel valve 79 and the throttle 47.

As shown, the second control scheme 420 includes an engine control portion 422 and a fuel properties computation portion 424. In the illustrated embodiment, the engine control portion 422 includes a governor controller 426. In certain embodiments, the governor controller 426 is a proportional integral derivative (PID) controller. In certain embodiments, the governor controller 426 is a proportional integral (PI) controller. The engine control portion 422 also includes an air-fuel ratio feedforward model 428 and an air-fuel ratio controller 430. In certain embodiments, the air-fuel ratio controller 430 is a PID controller. In certain embodiments, the air-fuel ratio controller 430 is a PI controller. The engine control portion 422 also includes a feedback model 432 that receives feedback of an oxygen value (e.g., oxygen content) of an exhaust of the one or more engines 20.

As shown, the fuel properties computation portion 424 includes a diluent correction 434. As discussed herein, the diluent correction 434 includes a diluent feedback portion 436 and, in certain embodiments, a diluent feedforward portion 438. As shown, the fuel properties computation portion 424 also includes an sAFR computation 440, a short term filter 442 (e.g., low pass filter), and a fuel properties computation 444. In the illustrated embodiment, the fuel properties computation portion 424 additionally includes a long term filter 445. In certain embodiments, the diluent includes an exhaust gas recirculation (EGR) gas, an inert gas (e.g., nitrogen or carbon dioxide), or a combination thereof.

As shown, the governor controller 426 receives an engine speed differential 446 determined by taking the difference between a commanded speed 448 (e.g., reference speed, shown as Spd_{cmd}) and a measured speed 450 (e.g., Spd) of the one or more engines 20. The governor controller 426 also receives fuel properties 452 determined via the fuel properties computation 444. The governor controller 426 outputs a commanded fuel volumetric flow rate 454 (e.g., Q_{fuel cmd}). The commanded fuel volumetric flow rate 454 is received by the fuel valve 79, which outputs an actual fuel volumetric flow rate 456 (e.g., Q_{fuel}) to the one or more engines 20. As shown, the fuel valve 79 (e.g., fuel valve model) also receives fuel properties 452 determined via the fuel properties computation 444. The commanded fuel volumetric flow rate 454 is also received by the air-fuel ratio feedforward model 428. As shown, the air-fuel ratio feedforward model 428 also receives a commanded excess air ratio 458 (e.g., λ_{cmd}). The air-fuel ratio feedforward model 428 outputs a throttle volumetric flow rate feedforward term 460 (e.g., Q_{thr fww}). As shown, the air-fuel ratio feedforward model 428 also receives fuel properties 452 determined via the fuel properties computation 444.

Additionally or alternatively, an excess air ratio differential 461 is computed by taking the difference between the commanded excess air ratio 458 and an exhaust excess air ratio 462 (e.g., λₑₓₕ) output by the feedback model 432. The excess air ratio differential 461 is received by the air-fuel ratio controller 430. The air-fuel ratio controller 430 outputs a throttle volumetric flow rate feedback term 464 (e.g., Q_{thr fb}). The throttle volumetric flow rate feedforward term 460 and the throttle volumetric flow rate feedback term 464 are summed to produce a commanded throttle volumetric flow rate 466 (e.g., Q_{thr cmd}), which is received by the throttle 47. That is, the volumetric flow rate feedback term 464 may correct the volumetric flow rate feedforward term 460. The throttle 47 outputs an actual throttle volumetric flow rate 468, which determines a volumetric flow rate of the throttle (e.g., air) to the one or more engines 20. As shown, the throttle 47 (e.g., throttle model) receives the fuel properties 452 determined via the fuel properties computation 444, which may influence one or more operational parameters of the throttle 47.

The sAFR computation 440 receives the commanded fuel volumetric flow rate 454, the commanded throttle volumetric flow rate 466, and the commanded excess air ratio 458. In certain embodiments, the sAFR computation 440 may compute an instant sAFR value 470, as discussed in further detail herein. The instant sAFR value 470 is received by the short term filter 442. Additionally or alternatively, the sAFR computation 440 may receive the sAFR estimate described in FIG. 3. In certain embodiments, the short term filter 442 may determine a short term filter estimated sAFR value 474 based on the following equation:

$${sAFR}_{ST} ( k ) = α {sAFR}_{ST} ( k - 1 ) + ( 1 - α ) {sAFR}_{inst} ( k )$$

In the above equation, α is a calibration parameter that determines the speed of response of the filter, sAFR_{ST}(k−1) is a short term filter sAFR estimate 474 at the k−1 time step, sAFRᵢₙₛₜ(k) is the instant sAFR value 470 at the k time step, and sAFR_{ST}(k) is the short term filter sAFR estimate 474 at the k time step, which is received by the fuel properties computation 444. In certain embodiments, the short term filter 442 is a first order low pass filter. Additionally or alternatively, the short term filter 442 may include a higher order filter, a moving average, or a combination thereof. It may be appreciated that the short term filter 442 removes higher frequency components (e.g., noise) from the instant sAFR value 470.

In certain embodiments, the short term filter sAFR estimate 474 is sent to the long term filter 445, which may compute a long term filter sAFR estimate 478 according to the following equation:

$${sAFR}_{LT} ( k ) = β {sAFR}_{LT} ( k - 1 ) + ( 1 - β ) {sAFR}_{ST} ( k )$$

In the above equation, β is a calibration parameter that determines the speed of response of the filter, sAFR_{ST}(k) is the short term filter sAFR estimate 474 at the k time step, sAFR_{LT}(k−1) is a long term filter sAFR estimate 478 at the k−1 time step, and sAFR_{LT}(k) is the long term filter sAFR estimate 478 at the k time step, which may be received by a starter engine, the one or more engines 20, or a combination thereof. In certain embodiments, the long term filter 445 is a first order low pass filter. Additionally or alternatively, the long term filter 445 may include a higher order filter, a moving average, or a combination thereof. It may be appreciated that the long term filter 445 may provide an estimate of the average sAFR over a longer period of time.

As shown, the diluent feedback portion 436 receives the throttle volumetric flow rate feedback term 464. As discussed herein, in certain embodiments, the diluent feedback portion 436 may include a PID controller, a PI controller, or a combination thereof (e.g., a switching controller). In certain embodiments, the proportional gain, the integral gain, and/or the derivative gain may be constants (e.g., time invariant) or may vary with time (e.g., time variant). The diluent feedback portion 436 may use the following equations:

$${C}_{diluent Int} ( k ) = {K}_{I} T {Q}_{thr fb} ( k ) + {C}_{diluent Int} ( k - 1 )$$

$${C}_{diluent} ( k ) = {K}_{P} {Q}_{thr fb} ( k ) + {C}_{diluent Int} ( k )$$

In the above equations, C_{diluent Int}(k) is a diluent integral term at the time step k, K_{I} is an integral gain, T is a sample time of the controller 94, C_{diluent Int}(k−1) is the diluent integral term at the time step k−1, K_{P} is a proportional gain, Q_{thr fb}(k) is the throttle volumetric flow rate feedback term 464, and C_{diluent}(k) is a diluent feedback term 480 (e.g., diluent concentration). In certain embodiments, the diluent feedback portion 436 adjusts the diluent feedback term 480 until the throttle volumetric flow rate feedback term 464 becomes zero and/or until the air-fuel ratio feedforward model 428 predicts a throttle volumetric flow rate feedforward term 460 that is substantially correct.

In certain embodiments, the instant sAFR value 470 is received by the diluent feedforward portion 438, which outputs a diluent feedforward term 482. In certain embodiments, the diluent feedback term 480 and the diluent feedforward term 482 are summed to produce a diluent concentration estimate 484, which is received by the fuel properties computation 444. In certain embodiments, the diluent concentration estimate 484 is the diluent feedback term 480 without the diluent feedforward term 482.

In the illustrated embodiment, the fuel valve 79 is shown as being used for controlling a speed 486 of the engine 20, and the throttle 47 is shown as being used for controlling an exhaust oxygen concentration 488, and thereby the air fuel ratio. In certain embodiments, the throttle 47 may be used for controlling the speed 486 of the engine 20, and the fuel valve 79 may be used for controlling the exhaust oxygen concentration 488 Additionally or alternatively, it may be recognized that a volumetric flow rate (e.g., volumetric air flow rate, volumetric fuel flow rate) may be converted to a mass flow rate (e.g., mass air flow rate, mass fuel flow rate).

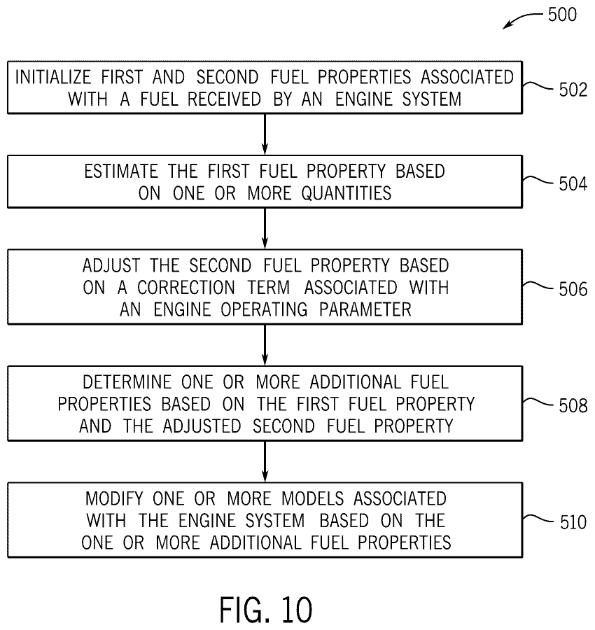

FIG. 10 is a flow chart of an embodiment of a process 500 for updating one or more fuel properties associated with operation of the engine system. The process 500 may be performed using the controller 94 shown in FIG. 1. In certain embodiments, the process 500 may be performed using other suitable control systems and/or computing device(s) or controller(s). Furthermore, the blocks of the process 500 may be performed in the order disclosed herein or in any other suitable order. For example, certain blocks of the process 500 may be performed concurrently. In addition, in certain embodiments, at least one of the blocks of the process 500 may be omitted. In certain embodiments, the process 500 may be stored on a tangible, non-transitory, computer-readable medium that, when executed by suitable control systems and/or computing device(s), may cause an electronic device to execute the process 500 described herein.

In block 502 of the process 500, the one or more processors of the controller 94 initialize first and second fuel properties associated with a fuel received by the engine system based on a state of the engine, a value entered by an operator, and/or a value stored in nonvolatile memory from the most recent engine shutdown. In certain embodiments, the fuel is a blend of two or more constituents whose concentrations are determined as a function of sAFR. For example, the fuel may include a blend of hydrogen (H₂), carbon dioxide (CO₂), nitrogen (N₂), alkane hydrocarbons (e.g., methane [CH₄], ethane, propane, butane, pentane, hexane, etc.), or a combination thereof. In certain embodiments, the fuel is a blend of CH₄ and a diluent. In certain embodiments, the first fuel property is the sAFR of the fuel received by the engine system and the second fuel property is a diluent concentration of the fuel received by the engine system.

In block 504 of the process 500, the one or more processors of the controller 94 estimate the first fuel property based on one or more quantities. In certain embodiments, the one or more quantities include the commanded throttle volumetric flow rate (e.g., volumetric air flow, [Q_{thr cmd}]), the commanded fuel volumetric flow rate (e.g., volumetric fuel flow (e.g., volumetric fuel flow, [Q_{fuel cmd}]), commanded excess air ratio, or a combination thereof. As discussed herein, the first fuel property may include the sAFR of the fuel, which may be determined according to the following equation:

$${sAFR}_{inst} ( k ) = \frac{1}{{λ}_{cmd} ( k - 1 )} \frac{{Q}_{{thr}_{cmd}} ( k - 1 )}{{Q}_{{fuel}_{cmd}} ( k - 1 )}$$

In the above equation, λcmd(k−1) is the commanded excess air ratio at the time step k−1, Q_{fuel}_{_{cmd}}(k−1) is the commanded fuel volumetric flow rate at the time step k−1, Qₐᵢᵣ_{_{cmd}}(k−1) is the commanded throttle volumetric flow rate at the time step k−1, and sAFRₑₛₜ(k) is the instant sAFR value at the time step k. In certain embodiments, the exhaust excess air ratio may be used in place of the commanded excess air ratio in the above equation. In certain embodiments, the commanded throttle volumetric flow rate may be replaced with an estimated throttle volumetric flow rate based on an estimated total engine flow minus the commanded fuel volumetric flow rate. As discussed herein, in certain embodiments, the instant sAFR may be further refined via a short term filter and/or a long term filter. In certain embodiments, the above equation may include additional terms that involve quantities taken from previous timesteps. For example, the above equation may include a second term including Qₐᵢᵣ_{_{cmd}}(k−2) (e.g., commanded throttle volumetric flow rate at the time step k−2) and/or Q_{fuel}_{_{cmd}}(k−2) (e.g., commanded fuel volumetric flow rate at the time step k−2).

In block 506 of the process 500, the one or more processors of the controller adjust the second fuel property based on an error (e.g., correction term) associated with an engine operation variable (e.g., controlled engine operation variable). In certain embodiments, adjusting the second fuel property includes determining a first feedback term associated with the second fuel property via a proportional integral (PI) controller that receives the error associated with the engine operation variable. For example, adjusting the second fuel property may include a summation of the first feedback term with a feedforward term based on the estimated first fuel property. In certain embodiments, the PI controller may adjust the second fuel property using the equations discussed in FIG. 2. In certain embodiments, the engine operation variable is an air-fuel ratio.

In block 508 of the process 500, the one or more processors of the controller determine one or more additional fuel properties based on the first fuel property and the adjusted second fuel property. In certain embodiments, the one or more additional fuel properties include a sAFR of hydrocarbon constituents of the fuel, a molecular weight of the fuel, a lower heating value of the fuel, a specific gravity of the fuel, a ratio of specific heats, or a combination thereof. A molecular weight of the hydrocarbon constituents (MW_{HC}), a lower heating value of the hydrocarbon constituents (LHV_{HC}), and/or a constant pressure specific heat of the hydrocarbon constituents (Cp_{HC}) may be determined based on the sAFR of the hydrocarbon constituents. As discussed herein, the molecular weight of the hydrocarbon constituents, the lower heating value of the hydrocarbon constituent, and/or the constant pressure specific heat of the hydrocarbon constituents may be used to determine the one or more additional fuel properties.

In block 510 of the process 500, the one or more processors of the controller modify one or more models associated with the engine system based on the one or more additional fuel properties. In certain embodiments, the one or more models associated with the engine system may include a model associated with the governor, a model associated with the fuel valve, a model associated with the throttle, a model associated with feedback received from the engine (e.g., a feedback oxygen signal), a model associated with determining an air-fuel ratio feedforward value, or a combination thereof.

In certain embodiments, a combination of the blocks 502-510 may be used for control of an engine via adjusting the engine inputs (e.g., Q_{fuel}, Qₜₕᵣ) and/or adjusting the control of the fuel valve, the throttle, the governor, or a combination thereof. Additionally or alternatively, a combination of the blocks 502-510 may be repeated iteratively. That is in response to a completion of any of the blocks 502-510, the process may iterate to another block in a cyclical manner. For example, in response to a completion of the block 510, the process 500 may reiterate starting at block 502.

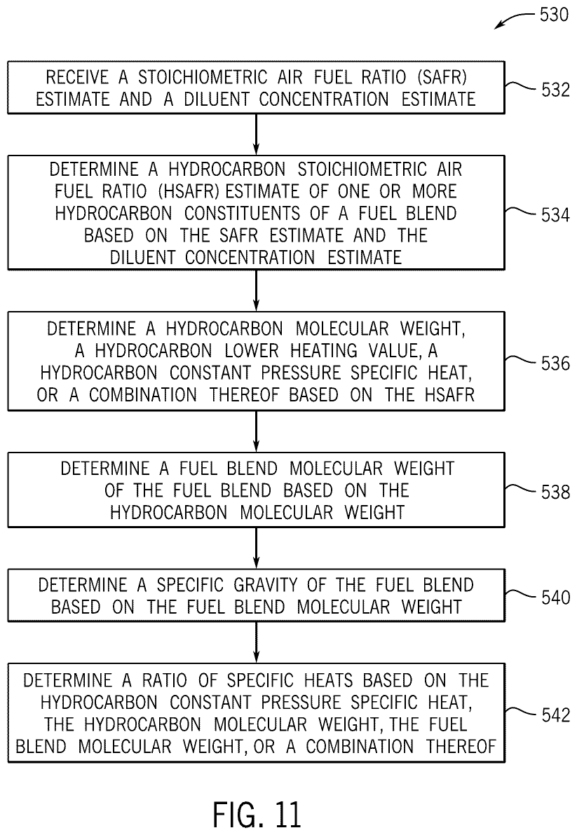

FIG. 11 is a flow chart of an embodiment of a process 530 for updating the one or more fuel properties of FIG. 8. The process 530 may be performed using the controller 94 shown in FIG. 1. In certain embodiments, the process 530 may be performed using other suitable control systems and/or computing device(s) or controller(s). Furthermore, the blocks of the process 530 may be performed in the order disclosed herein or in any other suitable order. For example, certain blocks of the process 530 may be performed concurrently. In addition, in certain embodiments, at least one of the blocks of the process 530 may be omitted. In certain embodiments, the process 530 may be stored on a tangible, non-transitory, computer-readable medium that, when executed by suitable control systems and/or computing device(s), may cause an electronic device to execute the process 530 described herein.

In block 532 of the process 530, the one or more processors of the controller receive an sAFR estimate and a diluent concentration estimate. For example, the sAFR estimate may be received from the sAFR computation, which may determine the instant sAFR as discussed herein. Additionally or alternatively, the diluent concentration estimate may be received from the diluent correction portion (e.g., including the diluent feedback portion and/or the diluent feedforward portion). In certain embodiments, the instant sAFR and/or the diluent concentration estimate may be filtered via a short term filter and/or a long term filter.

In block 534 of the process 530, the one or more processor of the controller determine a hydrocarbon stoichiometric air fuel ratio estimate of one or more hydrocarbon constituents of the fuel (e.g., fuel blend) based on the sAFR estimate and the diluent concentration estimate. In certain embodiments, the hydrocarbon stoichiometric air fuel ratio estimate of hydrocarbon constituents of the fuel may be determined based on the following equation:

$${sAFR}_{HC} ( k ) = \frac{{sAFR}_{ST} ( k )}{1 - {C}_{diluent} ( k )}$$

In the above equation, sAFR_{ST}(k) is the short term filter sAFR estimate at the k time step, C_{diluent}(k) is the diluent feedback term at the k time step, and sAFR_{HC}(k) is the sAFR estimate of the hydrocarbon constituents of the fuel at k time step.

In block 536 of the process 530, the one or more processors of the controller determine a hydrocarbon molecular weight estimate of the one or more hydrocarbon constituents, a hydrocarbon lower heating value of the one or more hydrocarbon constituents, a hydrocarbon constant pressure specific heat of the one or more hydrocarbon constituents, or a combination thereof based, on the hydrocarbon stoichiometric air fuel ratio estimate of the hydrocarbon constituents. In certain embodiments, the hydrocarbon molecular weight, the hydrocarbon lower heating value, the hydrocarbon constant pressure specific heat, or a combination thereof, may be determined based on one or more look-up tables and/or the hydrocarbon stoichiometric air fuel ratio estimate.

In block 538 of the process 530, the one or more processors of the controller determine a fuel blend molecular weight of the fuel (e.g., fuel blend) based on the hydrocarbon molecular weight. In certain embodiments, the fuel blend molecular weight may be determined based on the following equation:

$$MW ( k ) = {MW}_{HC} ( k ) [ 1 - {C}_{diluent} ( k ) ] + {MW}_{diluent} {C}_{diluent} ( k )$$

In the above equation, C_{diluent}(k) is the diluent feedback term (e.g., diluent concentration) at time step k, MW_{diluent} is a molecular weight of the diluent, MW_{HC}(k) is the hydrocarbon molecular weight estimate at time step k, and MW(k) is the molecular weight of the fuel at time step k.

In block 540 of the process 530, the one or more processors of the controller determine a specific gravity of the fuel blend based on the fuel blend molecular weight. In certain embodiments, the specific gravity of the fuel blend may be determined based on the following equation:

$$SG ( k ) = \frac{MW ( k )}{{MW}_{air}}$$

In the above equation, MW(k) is the molecular weight of the fuel at time step k, MWₐᵢᵣ is the molecular weight of air, and SG(k) is the specific gravity of the fuel blend at time step k.

In block 542 of the process 530, the one or more processors of the controller determine a ratio of specific heats based on the hydrocarbon constant pressure specific heat, the hydrocarbon molecular weight, the fuel blend molecular weight, or a combination thereof. In certain embodiments, the ratio of specific heats may be determined based on the following equation:

$$γ ( k ) = \frac{{Cp}_{HC} ( k ) {MW}_{HC} ( k ) [ 1 - {C}_{diluent} ( k ) ] + {Cp}_{diluent} {MW}_{diluent} {C}_{diluent} ( k )}{\begin{matrix}{Cp}_{HC} ( k ) {MW}_{HC} ( k ) [ 1 - {C}_{diluent} ( k ) ] + \\ {Cp}_{diluent} {MW}_{diluent} {C}_{diluent} ( k ) - \frac{{R}_{u}}{MW ( k )}\end{matrix}}$$

In the above equation, Cp_{HC}(k) is the hydrocarbon constant pressure specific heat at time step k, Cp_{diluent} is the diluent constant pressure specific heat, Rᵤ is a universal gas constant, and γ(k) is the ratio of specific heats at time step k. In certain embodiments, a combination of the blocks 532-542 may be used for control of the engine based on adjusting the ratio of specific heats at each time step. It may be appreciated that by having a more accurate estimate of the ratio of specific heats at a given time step may improve control of the engine. In certain embodiments, the fuel valve and/or the throttle may be controlled based on the updated ratio of specific heats.

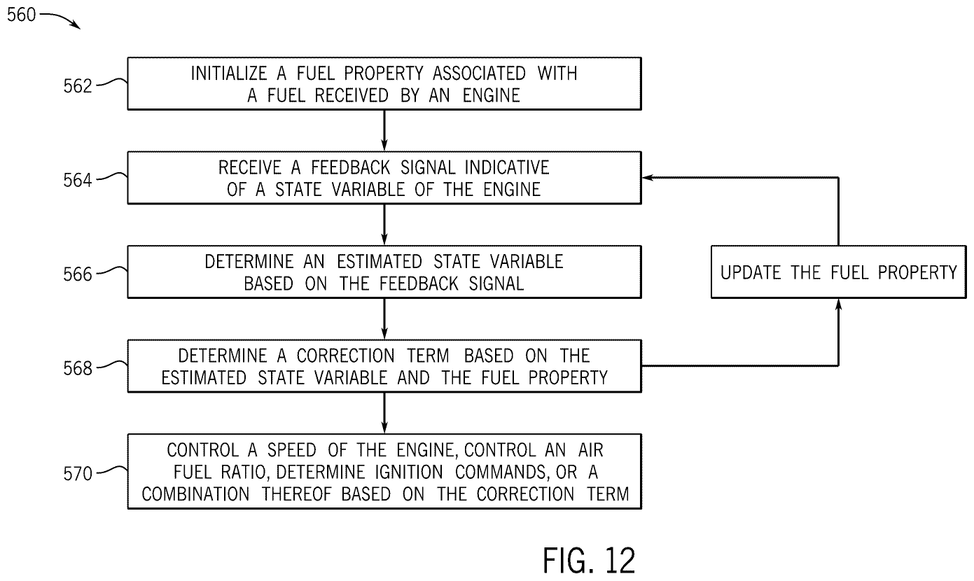

FIG. 12 is a flow chart of an embodiment of a process 560 for controlling the engine system of FIG. 1 based on the updated one or more fuel properties of FIG. 8. The process 560 may be performed using the controller 94 shown in FIG. 1. In certain embodiments, the process 560 may be performed using other suitable control systems and/or computing device(s) or controller(s). Furthermore, the blocks of the process 560 may be performed in the order disclosed herein or in any other suitable order. For example, certain blocks of the process 560 may be performed concurrently. In addition, in certain embodiments, at least one of the blocks of the process 560 may be omitted. In certain embodiments, the process 560 may be stored on a tangible, non-transitory, computer-readable medium that, when executed by suitable control systems and/or computing device(s), may cause an electronic device to execute the process 560 described herein.

In block 562 of the process 560, the one or more processors of the controller initialize a fuel property associated with a fuel received by an engine system based on a state of the engine system, a value entered by an operator, and/or a value stored in nonvolatile memory from the most recent engine shutdown. As discussed herein, in certain embodiments the initialized fuel property may include an sAFR of a fuel, a diluent concentration, or a combination thereof.

In block 564 of the process 560, the one or more processors of the controller receive a feedback signal indicative of an operating variable of an engine. In certain embodiments, the feedback signal may be received via one or more sensors (e.g., oxygen sensors, thermocouples, etc.) disposed within the engine system. In certain embodiments, the operating variable may include a temperature, a pressure, a mass/volumetric flowrate (e.g., oxygen volumetric flow rate, oxygen concentration, oxygen mass flow rate), an engine speed, or a combination thereof.

In block 566 of the process 560, the one or more processors of the controller determine an estimated operating variable based on the feedback signal. In certain embodiments, the determining the estimated operating variable includes using the feedback signal to estimate a different type of variable than the variable indicated by the feedback signal. For example, as discussed herein, an oxygen value received from the engine may be used to estimate the sAFR, an air-fuel ratio, or both.

In block 568 of the process 560, the one or more processors of the controller determine an error based on the estimated operating variable and the estimated fuel property. For example, as discussed herein, the throttle volumetric flow rate feedback term (e.g., error term) is determined based on an error between a commanded excess air ratio, and a measured (e.g., feedback) excess air ratio based on an oxygen measurement.

In block 570 of the process 560, the one or more processors of the controller control a speed of the engine system, control an air fuel ratio, determine ignition commands, or a combination thereof based on the error. In certain embodiments, the commanded speed may be sent to the governor and/or the fuel value, the air fuel ratio may be sent to the throttle (e.g., as a feedforward term), and/or the ignition commands may be sent to the engine system.

In block 572 of the process 560, the one or more processors of the controller update the fuel property in response to determination of the error. For example, as discussed herein, the sAFR and diluent concentration estimates are adjusted based on the throttle volumetric flow rate feedback term (e.g., error term). As shown, in response to the fuel property update, the process 560 iterates to block 564. In certain embodiments, a combination of the blocks 562-572 may be used for control of the engine based on the commanded speed being sent to the governor and/or the fuel value, the air fuel ratio being sent to the throttle (e.g., as a feedforward term), and/or the ignition commands may be sent to the engine. In certain embodiments, a combination of the fuel valve, the throttle, and the engine may be controlled based on the commanded speed, the estimated air fuel ratio, and/or estimated ignition commands.

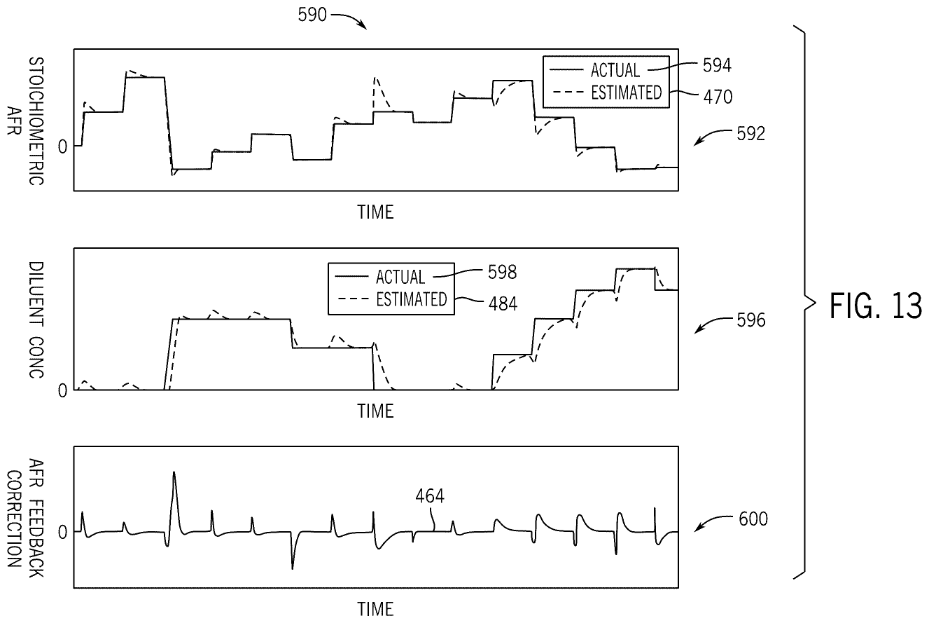

FIG. 13 is a series of plots 590 showing an embodiment of simulation results of controlling the engine system based on the updated one or more fuel properties of FIG. 8. As shown, plot 592 shows an actual (e.g., empirical) sAFR value 594, and the sAFR estimate 470. In certain embodiments, the sAFR estimate 470 is filtered via the short term filter and/or the long term filter. As shown, the sAFR estimate 470 tracks the actual sAFR value 594 in response to multiple step changes in the actual sAFR value 594.

As shown, plot 596 shows an actual (e.g., empirical) diluent concentration 598 and the diluent concentration estimate 484. As shown, the diluent concentration estimate 484 tracks the actual diluent concentration 598 in response to multiple step changes in the actual diluent concentration 598.

As shown, plot 600 shows the air fuel ratio feedback correction (e.g., throttle volumetric flow rate feedback term 464) over time. As shown, the throttle volumetric flow rate feedback term 464 generally remains close to zero, but moves away from zero momentarily during step changes in either the actual sAFR value 594 and/or the actual diluent concentration 598.

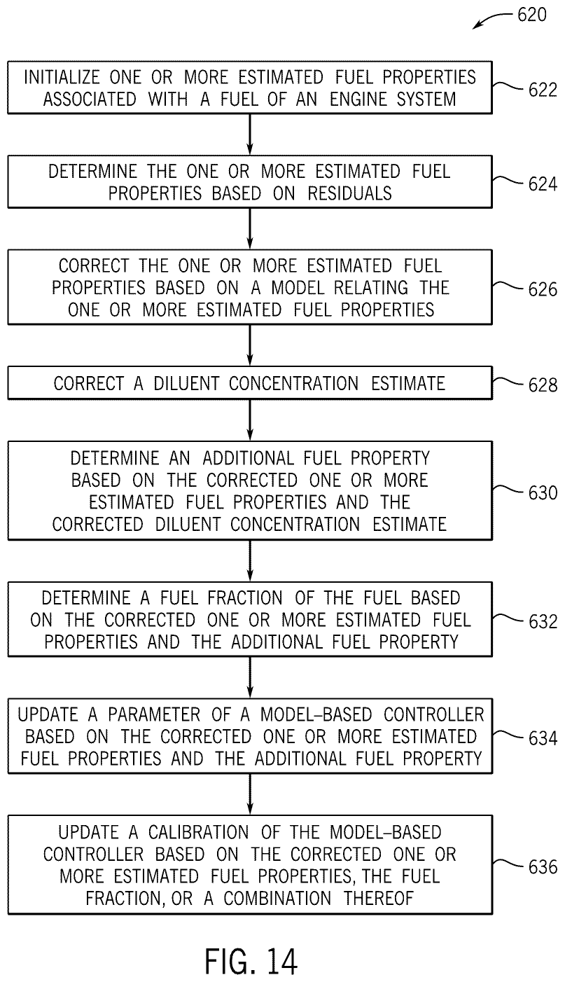

FIG. 14 is a flow chart of an embodiment of a process 620 including the first control scheme 130 of FIG. 2 and the second control scheme 420 of FIG. 7 for operation of the engine system of FIG. 1. The process 620 may be performed using the first control scheme 130 of FIG. 2 and the second control scheme 420 of FIG. 7 implemented on the controller 94 in FIG. 1. In certain embodiments, the process 620 may be performed using other suitable control systems and/or computing device(s) or controller(s). Furthermore, the blocks of the process 620 may be performed in the order disclosed herein or in any other suitable order. For example, certain blocks of the process 620 may be performed concurrently. In addition, in certain embodiments, at least one of the blocks of the process 620 may be omitted. In certain embodiments, the process 620 may be stored on a tangible, non-transitory, computer-readable medium that, when executed by suitable control systems and/or computing device(s), may cause an electronic device to execute the process 620 described herein.

In block 622 of the process 620, the one or more processors of the controller initialize one or more estimated fuel properties associated with a fuel of the engine. In certain embodiments, the initial one or more fuel properties may be determined based on one or more operating parameters (e.g., conditions) of the engine, a value entered by an operator, and/or a value stored in nonvolatile memory from the most recent engine shutdown. In certain embodiments, the one or more estimated fuel properties includes a stoichiometric air fuel ratio (sAFR), a lower heating value (LHV), or a combination thereof. In certain embodiments, block 622 may be implemented by the first control scheme 130 as discussed herein.

In block 624 of the process 620, the one or more processors of the controller determine the one or more estimated fuel properties based on residuals. For example, the one or more estimated fuel properties may be determined by first determining a residual of a related quantity and proceeding to solve a differential equation as part of an initial value problem, as described in FIGS. 2-5. In certain embodiments, block 624 may be implemented by the first control scheme 130 as discussed herein.

In block 626 of the process 620, the one or more processors of the controller correct the one or more estimated fuel properties based on a model that relates the one or more estimated fuel properties. For example, the one or more estimated fuel properties may be corrected via a Kalman filter that uses the model that relates the one or more estimated fuel properties. In certain embodiments, the Kalman filter may be an extended Kalman filter, an unscented Kalman filter, or any other state observer. In certain embodiments, block 626 may be implemented by the first control scheme 130 as discussed herein.

In block 628 of the process 620, the one or more processors of the controller correct a diluent fraction estimate (e.g., diluent concentration estimate). As discussed herein, the diluent concentration estimate may be corrected based on the throttle volumetric flow rate feedback term and/or another feedback term associated with the air-fuel ratio. In certain embodiments, block 628 may be implemented by the second control scheme 420 as discussed herein. In certain embodiments, block 628 may be omitted.

In block 630 of the process 620, the one or more processors of the controller determine an additional fuel property based on the corrected one or more estimated fuel properties. For example, the additional fuel property may include a density of the fuel, a specific heat of the fuel, a minimum stoichiometric air demand, a hydrocarbon content, an inert gas fraction, or a combination thereof. In certain embodiments, the one or more processors of the controller may determine the additional fuel property based on the corrected one or more estimated fuel properties and the corrected diluent concentration estimate determined in block 628. In certain embodiments, block 630 may be implemented by the first control scheme 130 as discussed herein.

In block 632 of the process 620, a fuel fraction of the fuel is determined based on the corrected one or more estimated fuel properties and/or the additional fuel property. In certain embodiments, the fuel may include two or more constituents having different concentrations. In certain embodiments, block 632 may be implemented by the first control scheme 130 as discussed herein.

In block 634 of the process 620, the one or more processors of the controller update a parameter of a model based controller based on the corrected one or more estimated fuel properties and/or the additional fuel property. For example, a gain (e.g., coefficient), a weight, and/or a variable of the model based controller may be adjusted. As discussed herein, the model based controller may include a power controller of the engine system, a speed controller (e.g., rotational speed controller) of the engine system, a torque controller of the engine system, or a combination thereof. In certain embodiments, block 636 may be implemented by the first control scheme 130 as discussed herein.

In block 636 of the process 620, the one or more processors of the controller update a calibration of the model based controller based on the corrected one or more estimated fuel properties and/or the additional fuel property. As discussed herein, the one or more estimated fuel properties may include the sAFR, the LHV, and/or gas constituent fractions (e.g., hydrogen content). In certain embodiments, the additional fuel property may include the density of the fuel, limits of the excess air ratio, and/or ignition timing properties. In certain embodiments, block 638 may be implemented by the first control scheme 130 as discussed herein.

It may be recognized that controller 94, or any other suitable controller, may be configured to execute any combination of the first control scheme 130 and the second control scheme 420. That is, the controller 94 may be configured to concurrently or separately execute any combination of the processes 250, 280, 310, 500, 530, 560, and 620 as described in FIGS. 3-5, 8-10, and 12 herein, via the first control scheme 130, the second control scheme 420, or a combination thereof.

Technical effects of the invention include determining gas parameters for the control of a gas engine for a correct gas dosage and selection of operational parameters such as knock and misfire limits, lambda limits, ignition timing, burn duration, and the like. Additionally, the determination of gas parameters may reduce model uncertainty for precise control of speed and power of the engine. Additionally, in the case of a mixture between two constituents for the fuel, the present disclosure may eliminate the need for the use of an additional sensor, such as a methane sensor or a hydrogen sensor. Additional technical effects include updating fuel property estimates based on correcting a diluent concentration estimate to improve the accuracy of the fuel properties, which may then be used to provide for more accurate control of the engine. Additional advantages of the improved fuel property estimation include more consistent engine transient performance without added sensors, automatic adaptation to changing fuel (e.g., fuel with different constituent concentrations), more reliable engine restarting, and not using a fresh air mass flow sensor.

The subject matter described in detail above may be defined by one or more clauses, as set forth below.

According to a first aspect, a method includes initializing an estimated fuel property associated with a fuel of an engine system. The method also includes determining an estimated quantity associated with operation of the engine based on a model. The method also includes receiving a signal indicative of a measured quantity corresponding to the estimated quantity. The method also includes determining the measured quantity based on the received signal. The method also includes determining a residual based on the estimated quantity and the measured quantity. The method also includes updating the estimated fuel property based on the residual. The method also includes controlling one or more operational parameters of the engine based on the update of the estimated fuel property.

The method of the preceding clause, including repeating the determining the estimated quantity, receiving the signal, determining the measured quantity, determining the residual, and updating the estimated fuel property to minimize the residual.

The method of any preceding clause, wherein the estimated fuel property is a stoichiometric air fuel ratio (sAFR), the estimated quantity is an oxygen concentration in an exhaust of the engine system, and the measured quantity is a measured oxygen concentration in the exhaust.

The method of any preceding clause, wherein the estimated fuel property is a diluent concentration in the fuel, the estimated quantity is an oxygen concentration in an exhaust of the engine system, and the measured quantity is a measured oxygen concentration in the exhaust.

The method of any preceding clause, wherein the estimated fuel property is a lower heating value (LHV), the estimated quantity is a generated engine power, a generated engine torque, or a combination thereof, and the measured quantity is a measured generated engine power, a measured generated engine torque, or a combination thereof.

The method of any preceding clause, wherein the estimated fuel property is a hydrogen content in the fuel of the engine system, the estimated quantity is a water content in an exhaust of the engine system, and the measured quantity is a measured water content in the exhaust.

The method of any preceding clause, wherein the estimated fuel property is a hydrogen content in the fuel of the engine system, the estimated quantity is an exhaust temperature, and the measured quantity is a measured exhaust temperature.

The method of any preceding clause, wherein the model includes a commanded mass flow rate, a measured mass flow rate, an estimated mass flow rate, or a combination thereof, corresponding to a flow of the fuel, a flow of air, or a combination thereof, in the engine system.

The method of any preceding clause, wherein controlling the one or more operational parameters of the engine includes adjusting a rotational speed controller of the engine system, a power controller of the engine system, a torque controller of the engine system, or a combination thereof, based on the update of the estimated fuel property.

The method of any preceding clause, wherein adjusting the rotational speed controller, the power controller, the torque controller, or the combination thereof, includes: updating parameters of a model based controller; updating gains of a proportional-integral-derivative (PID) controller; or a combination thereof.

The method of any preceding clause, wherein controlling the one or more operational parameters of the engine includes adjusting a boost pressure setpoint, an air fuel equivalence ratio setpoint, an ignition time setpoint, or a combination thereof, based on the update of the estimated fuel property.

The method of any preceding clause, wherein controlling the one or more operational parameters of the engine includes adjusting air fuel equivalence ratio limits, knock and misfire limits, or a combination thereof, based on the update of the estimated fuel property.

The method of any preceding clause, wherein the estimated fuel property includes a plurality of estimated fuel properties.

The method of any preceding clause, including determining one or more estimated fuel properties of the plurality of properties based on an observer and an additional signal.

According to a second aspect, a system includes an engine and a controller having a memory and a processor. The controller is configured to initialize an estimated fuel property associated with a fuel of the engine. The controller is also configured to determine an estimated quantity associated with operation of the engine based on a model. The controller is also configured to receive a signal indicative of a measured quantity corresponding to the estimated quantity. The controller is also configured to determine the measured quantity based on the received signal. The controller is also configured to determine a residual based on the estimated quantity and the measured quantity. The controller is also configured to update the estimated fuel property based on the residual. The controller is also configured to control one or more operational parameters of the engine based on the update of the estimated fuel property.

The system of the preceding clause, wherein the estimated fuel property is a stoichiometric air fuel ratio (sAFR), the estimated quantity is an oxygen concentration in an exhaust of the engine, and the measured quantity is a measured oxygen concentration in the exhaust.

The system of any preceding clause, wherein the estimated fuel property is a lower heating value (LHV), the estimated quantity is a generated engine power, a generated engine torque, or a combination thereof, and the measured quantity is a measured generated engine power, a measured generated engine torque, or a combination thereof.

The system of any preceding clause, wherein the fuel includes a first constituent and a second constituent, wherein a first concentration of the first constituent, a second concentration of the second constituent, or both, are determined based on the estimated fuel property.

According to a third aspect, a tangible, non-transitory, computer-readable medium, including computer-readable instructions that, when executed by one or more processors of an electronic device, cause the electronic device to initialize one or more estimated fuel properties associated with a fuel of an engine system. The computer-readable instructions also cause the electronic device to determine the one or more estimated fuel properties based on residuals. The computer-readable instructions also cause the electronic device to correct the one or more estimated fuel properties based on a model relating the one or more estimated fuel properties. The computer-readable instructions also cause the electronic device to estimate an additional fuel property based on the corrected one or more estimated fuel properties. The computer-readable instructions also cause the electronic device to determine a fuel fraction of the fuel based on the corrected one or more estimated fuel properties and the additional fuel property. The computer-readable instructions also cause the electronic device to update a parameter of a model-based controller based on the corrected one or more estimated fuel properties and the additional fuel property. The computer-readable instructions also cause the electronic device to update a calibration of the model-based controller based on the corrected one or more estimated fuel properties, the fuel fraction, or a combination thereof.

The tangible, non-transitory, computer-readable medium of any preceding clause, wherein the one or more estimated fuel properties include a stoichiometric air fuel ratio (sAFR), a lower heating value (LHV), or a combination thereof, and the additional fuel property includes a fuel density, a specific heat, or a combination thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method, comprising:
initializing an estimated fuel property associated with a fuel of an engine system;
determining an estimated quantity associated with operation of the engine based on a model;
receiving a signal indicative of a measured quantity corresponding to the estimated quantity;
determining the measured quantity based on the received signal;
determining a residual based on the estimated quantity and the measured quantity;
updating the estimated fuel property based on the residual; and
controlling one or more operational parameters of the engine based on the update of the estimated fuel property.

2. The method of claim 1, comprising repeating the determining the estimated quantity, receiving the signal, determining the measured quantity, determining the residual, and updating the estimated fuel property to minimize the residual.

3. The method of claim 1, wherein the estimated fuel property is a stoichiometric air fuel ratio (sAFR), the estimated quantity is an oxygen concentration in an exhaust of the engine system, and the measured quantity is a measured oxygen concentration in the exhaust.

4. The method of claim 1, wherein the estimated fuel property is a diluent concentration in the fuel, the estimated quantity is an oxygen concentration in an exhaust of the engine system, and the measured quantity is a measured oxygen concentration in the exhaust.

5. The method of claim 1, wherein the estimated fuel property is a lower heating value (LHV), the estimated quantity is a generated engine power, a generated engine torque, or a combination thereof, and the measured quantity is a measured generated engine power, a measured generated engine torque, or a combination thereof.

6. The method of claim 1, wherein the estimated fuel property is a hydrogen content in the fuel of the engine system, the estimated quantity is a water content in an exhaust of the engine system, and the measured quantity is a measured water content in the exhaust.

7. The method of claim 1, wherein the estimated fuel property is a hydrogen content in the fuel of the engine system, the estimated quantity is an exhaust temperature, and the measured quantity is a measured exhaust temperature.

8. The method of claim 1, wherein the model comprises a commanded mass flow rate, a measured mass flow rate, an estimated mass flow rate, or a combination thereof, corresponding to a flow of the fuel, a flow of air, or a combination thereof, in the engine system.

9. The method of claim 1, wherein controlling the one or more operational parameters of the engine comprises adjusting a rotational speed controller of the engine system, a power controller of the engine system, a torque controller of the engine system, or a combination thereof, based on the update of the estimated fuel property.

10. The method of claim 9, wherein adjusting the rotational speed controller, the power controller, the torque controller, or the combination thereof, comprises:
updating parameters of a model based controller;
updating gains of a proportional-integral-derivative (PID) controller;
or a combination thereof.

11. The method of claim 1, wherein controlling the one or more operational parameters of the engine comprises adjusting a boost pressure setpoint, an air fuel equivalence ratio setpoint, an ignition time setpoint, or a combination thereof, based on the update of the estimated fuel property.

12. The method of claim 1, wherein controlling the one or more operational parameters of the engine comprises adjusting air fuel equivalence ratio limits, knock and misfire limits, or a combination thereof, based on the update of the estimated fuel property.

13. The method of claim 1, wherein the estimated fuel property comprises a plurality of estimated fuel properties.

14. The method of claim 13, comprising determining one or more estimated fuel properties of the plurality of properties based on an observer and an additional signal.

15. A system, comprising:
an engine; and
a controller having a memory and a processor, wherein the controller is configured to:
initialize an estimated fuel property associated with a fuel of the engine;
determine an estimated quantity associated with operation of the engine based on a model;
receive a signal indicative of a measured quantity corresponding to the estimated quantity;
determine the measured quantity based on the received signal;
determine a residual based on the estimated quantity and the measured quantity;
update the estimated fuel property based on the residual; and
control one or more operational parameters of the engine based on the update of the estimated fuel property.

16. The system of claim 15, wherein the estimated fuel property is a stoichiometric air fuel ratio (sAFR), the estimated quantity is an oxygen concentration in an exhaust of the engine, and the measured quantity is a measured oxygen concentration in the exhaust.

17. The system of claim 15, wherein the estimated fuel property is a lower heating value (LHV), the estimated quantity is a generated engine power, a generated engine torque, or a combination thereof, and the measured quantity is a measured generated engine power, a measured generated engine torque, or a combination thereof.

18. The system of claim 15, wherein the fuel comprises a first constituent and a second constituent, wherein a first concentration of the first constituent, a second concentration of the second constituent, or both, are determined based on the estimated fuel property.

19. A tangible, non-transitory, computer-readable medium, comprising computer-readable instructions that, when executed by one or more processors of an electronic device, cause the electronic device to:
initialize one or more estimated fuel properties associated with a fuel of an engine system;
determine the one or more estimated fuel properties based on residuals;
correct the one or more estimated fuel properties based on a model relating the one or more estimated fuel properties;
estimate an additional fuel property based on the corrected one or more estimated fuel properties;
determine a fuel fraction of the fuel based on the corrected one or more estimated fuel properties and the additional fuel property;
update a parameter of a model-based controller based on the corrected one or more estimated fuel properties and the additional fuel property; and
update a calibration of the model-based controller based on the corrected one or more estimated fuel properties, the fuel fraction, or a combination thereof.

20. The tangible, non-transitory, computer-readable medium of claim 19, wherein the one or more estimated fuel properties comprise a stoichiometric air fuel ratio (sAFR), a lower heating value (LHV), or a combination thereof, and the additional fuel property comprises a fuel density, a specific heat, or a combination thereof.
